(19) United States
(12) Patent Application Publication
(10) Pub. No.: US 2010/0121697 A1
(43) Pub. Date: May 13, 2010

(54) METHODS, SYSTEMS AND COMPUTER PROGRAM PRODUCTS FOR A MOBILE TARGETED COUPON DISTRIBUTOR

(75) Inventors: Zhijian Lin, Dublin, CA (US); Eliezer K. Pasetes, San Ramon, CA (US)

Correspondence Address: VERIZON;PATENT MANAGEMENT GROUP, 1320 North Court House Road, 9th Floor, ARLINGTON, VA, 22201-2909, US

(73) Assignee: VERIZON CORPORATE RESOURCES GROUP LLC, Basking Ridge, NJ (US)

(21) Appl. No.: 12/269,237

(22) Filed: Nov. 12, 2008

(51) Int. Cl. G06Q 30/00

(52) U.S. Cl. 705/14.14; 705/26

(57) ABSTRACT

This disclosure details the implementation of methods, systems and computer program products for a mobile targeted coupon distributor (hereinafter, “Distributor”). Distributor embodiments may serve to facilitate users' specification of coupon preferences and the provision of coupons to mobile devices consistent with those preferences. In one embodiment, the Distributor may acquire and/or validate user coupon preferences, store those preferences, and subsequently direct the provision of coupons to a user's mobile device via short message service (SMS) text messages, multimedia messaging service (MMS) picture alerts, and/or the like. In one embodiment, coupon characteristics, such as the associated purchase discount amounts, may be determined based on one or more user-specific factors.

### BACKGROUND

Messaging systems for mobile communication devices have come about that complement traditional voice-based telephony. For example, short message service (SMS) protocols allow short text-based messages to be sent from one mobile communication device to another. Another example of such messaging systems are multimedia messaging service (MMS) protocols that allow for the exchange of messages containing multimedia objects such as images, video, audio, and the like. Additionally, data formats called data feeds have come about, allowing users to receive periodically updated information of interest on their computers. Content providers may syndicate content data to make it available to users via a feed link. Many content providers currently operate data feeds, including news organizations, websites, blogs, schools, and/or the like.

### BRIEF DESCRIPTION OF THE DRAWINGS

FIGS. 1A-1B show examples of implementations of coupon distribution to mobile devices in some embodiments of Distributor operation;

FIG. 2 provides an overview of an implementation of Distributor components and affiliated entities in one embodiment of Distributor operation;

FIGS. 3A-3B show an implementation of logic flow for coupon subscription in one embodiment of Distributor operation;

FIGS. 4A-4B show aspects of an implementation of a user interface for coupon subscription in one embodiment of Distributor operation;

FIGS. 5A-5B show an implementation of logic flow for retailer coupon generation in one embodiment of Distributor operation;

FIGS. 6A-6C show aspects of an implementation of a user interface for retailer coupon generation in one embodiment of Distributor operation;

FIGS. 7A-7B show two implementations of logic flow for coupon delivery to mobile devices in embodiments of Distributor operation;

FIG. 8 shows an implementation of logic flow for coupon authentication in one embodiment of Distributor operation;

FIG. 9 provides an overview of an implementation of Distributor components and affiliated entities in one embodiment of Distributor operation;

FIG. 10 shows an implementation of data flow for user feed subscription in one embodiment of Distributor operation;

FIG. 11 shows an implementation of logic flow for user feed subscription in one embodiment of Distributor operation;

FIGS. 12A-12B show aspects of an implementation of a user interface for user feed subscription in one embodiment of Distributor operation;

FIG. 13 shows an implementation of data flow for content delivery in one embodiment of Distributor operation;

FIG. 14 shows an implementation of logic flow for content delivery in one embodiment of Distributor operation;

FIG. 15 shows aspects of an implementation of a user interface for content delivery in one embodiment of Distributor operation; and

FIG. 16 is of a block diagram illustrating an exemplary embodiment of a Manager controller.

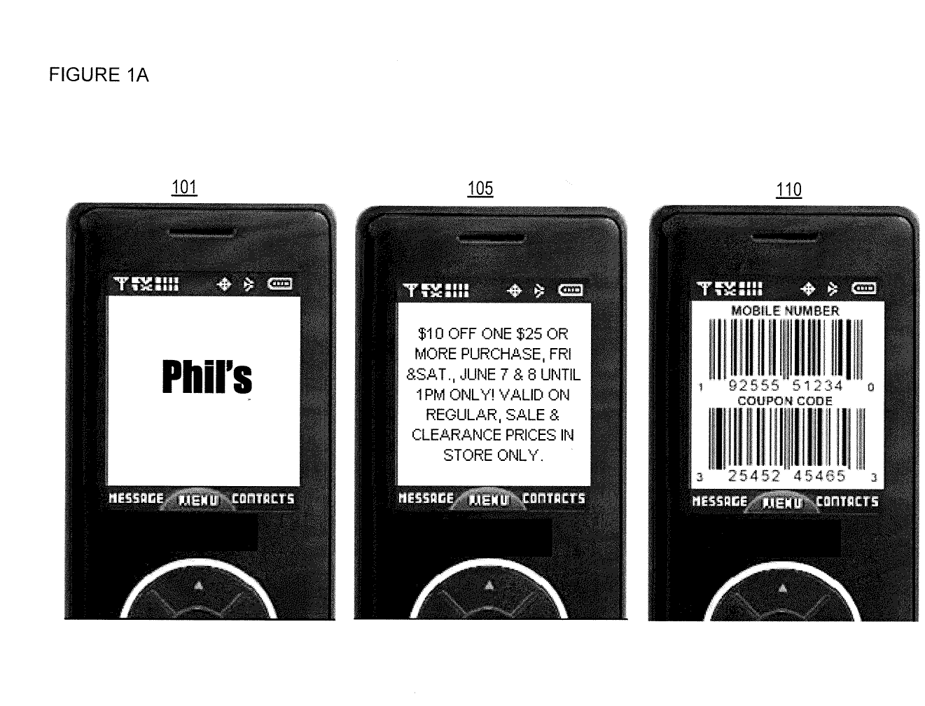

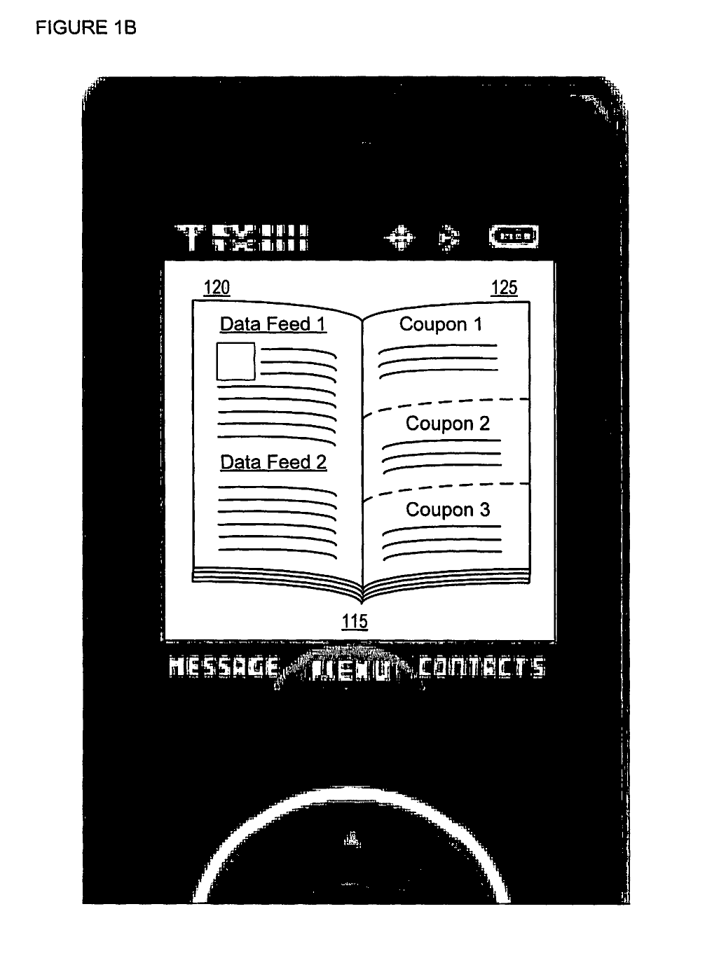

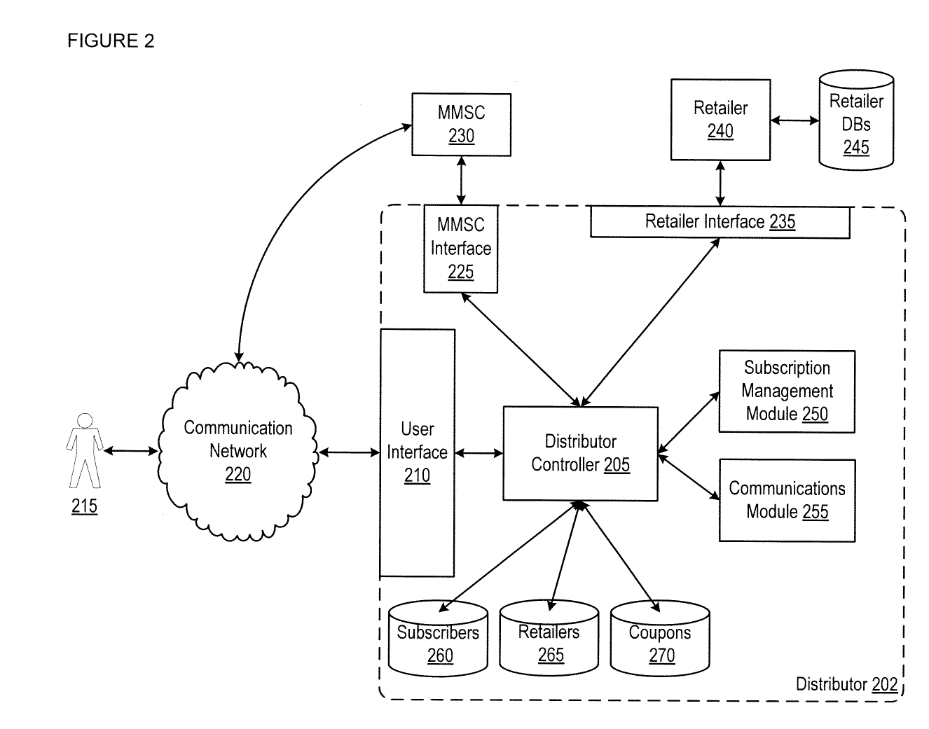

The leading number of each reference number within the drawings indicates the figure in which that reference number is introduced and/or detailed. As such, a detailed discussion of reference number 101 would be found and/or introduced in FIG. 1. Reference number 201 is introduced in FIG. 2, etc.

### DETAILED DESCRIPTION OF PREFERRED EMBODIMENTS

This disclosure details the implementation of methods, systems and computer program products for a mobile targeted coupon distributor (hereinafter, “Distributor”). Distributor embodiments may serve to facilitate users' specification of coupon preferences and the provision of coupons to mobile devices consistent with those preferences. In one embodiment, the Distributor may acquire and/or validate user coupon preferences, store those preferences, and subsequently direct the provision of coupons to a user's mobile device via short message service (SMS) text messages, multimedia messaging service (MMS) picture alerts, and/or the like. In one embodiment, coupon characteristics, such as the associated purchase discount amounts, may be determined based on one or more user-specific factors. In one embodiment, data feeds, such as web feeds, RSS feeds, Atom feeds, and/or the like, may be employed to carry information pertaining to user-selected coupons, retailer notices, and/or the like.

In one embodiment, a method is disclosed, comprising: receiving a user coupon subscription message from a user, the user coupon subscription message comprising a user identifier and an authorization to send coupons to a user mobile device; determining a retail identifier based on the user coupon subscription message; storing the retail identifier in association with the user identifier; receiving a coupon specification message comprising the retail identifier, a coupon code and a coupon benefit message; storing some part of the coupon specification message in association with the retail identifier; and providing a coupon message for distribution to a user mobile device associated with the user identifier, the coupon message configured with the coupon code and the coupon benefit message.

It is to be understood that, depending on the particular needs and/or characteristics of a Distributor user, administrator, retailer. coupon and/or discount program, data payload, monetization model, hardware configuration, network framework, and/or the like, various embodiments of the Distributor may be implemented that enable a great deal of flexibility and customization. The instant disclosure discusses embodiments of the Distributor primarily within the context of voluntary coupon program subscriptions and coupon distribution to personal mobile devices. However, it is to be understood that the system described herein may be readily configured/customized for a wide range of other applications or implementations. For example, aspects of the Distributor may be adapted for sale notices, product and/or customer specific advertising, non-mobile data display platforms, and/or the like applications. It is to be understood that the Distributor may be further adapted to other implementations or coupon distribution applications.

FIGS. 1A-1B show examples of implementations of coupon distribution to mobile devices in some embodiments of Distributor operation. A subscriber's mobile device 101 may be engaged by the Distributor to send a coupon thereto. A wide variety of mobile devices may be compatible with Distributor services in various implementations, such as but not limited to mobile telephones, personal digital assistants (PDAs), blackberries, iPhones, iPod Touches, and/or the like. It should be understood that the term coupon is used herein to mean any one-time use or multi-use discount, sale notice, benefit program, rebate, promotion, cause-related marketing donation, and/or the like. A subscriber's mobile device may indicate an incoming coupon to the subscriber, such as by ringing, buzzing, beeping, and/or the like, and one or more retailer names associated with the coupon may first be displayed, as in 101. The Distributor may also cause to be displayed one or more coupon messages 105, describing the benefit conferred upon the subscriber by the coupon, as well as any conditions, restrictions, expirations, limitations, and/or the like associated with the coupon. In one implementation, the Distributor may further cause to be displayed one or more coupon codes 110. Coupon codes may, in various implementations, comprise one or more alphanumeric codes, barcodes, matrix codes, images, audio and/or video codes, and/or the like. Coupon codes may, in one implementation, be scannable by a point-of-sale scanning device to validate the coupon and/or authorize and/or administer the associated benefit. In another implementation, coupon codes may comprise alphanumeric strings to be keyed in to a retailer terminal at the point of sale. In still another implementation, a coupon code may simply comprise a message, image, and/or the like to be shown to a retailer at the point-of-sale and understood by the retailer to confer a benefit upon the subscriber bearing the coupon. In one implementation, a first coupon code delivered to a subscriber's mobile device may embody information pertaining to a specific coupon while a second coupon code delivered to the subscriber's mobile device may embody subscriber and/or device specific information 110. In this scenario, a point-of-sale device may analyze both codes in order to validate the coupon and/or authorize and/or administer the associated coupon benefit.

In FIG. 1B, an embodiment of Distributor operation is shown in which content, data feeds, coupons, and/or the like may be presented to a subscriber in the form of a virtual coupon book, newspaper, newsletter, and/or the like. The virtual newspaper 115 shown in FIG. 1B may include “articles”, with content supplied by user selected data feeds 120, and coupons 125, supplied based on user coupon subscriptions. In one implementation, a subscriber may engage a data feed and/or coupon to be provided a closer look, be provided more information, reveal coupon codes, and/or the like by selecting the data feed or coupon with an interface element (e.g., by highlighting the data feed or coupon, or by pointing at it with a pointer element, and clicking a button). In one implementation, the virtual publication may be implemented by an applet running on the subscriber's mobile device configured to receive data feed content data and/or coupon data and format them in the form of a virtual publication, such as may be based on a virtual publication template. In another implementation, the virtual publication may be generated as a multimedia web application, such as may be created using multimedia web publishing software such as Adobe Flash, and hosted on a web site. The subscriber may then access the virtual publication using a web-enabled mobile device.

FIG. 2 provides an overview of an implementation of Distributor components and affiliated entities in one embodiment of Distributor operation. The Distributor 201 may contain a number of functional modules and/or data stores. A Distributor controller 205 may serve a central role in some embodiments of Distributor operation, serving to orchestrate the reception, generation, and distribution of data and/or instructions to, from and between Distributor modules and/or mediate communications with external entities and systems. An external user 215, who may be equipped with a communications enabled computing terminal and/or mobile device, may access Distributor services via a communications network 220. A Distributor user interface 210 may be configured to receive user subscription requests, coupon specifications, and/or instructions, relay Distributor messages and/or retailer data, and/or the like.

In one implementation, the Distributor controller 205 may further be coupled to a MMS Center (MMSC) 230, equipped to process received coupon data into one or more MMS messages, picture alerts, and/or the like and to send generated messages to any of a variety of destinations, mobile devices, and/or the like, such as to a subscriber's 215 mobile device via a communications network 220. In an alternative implementation, the Distributor may be coupled to one or more facilities equipped to mediate SMS messages and/or other mobile messaging formats in addition to and/or instead of MMS messages. The Distributor controller may engage, access and/or communicate with the MMSC 230 via an MMSC interface 225, which may serve to configure coupon data provided to the MMSC into one or more formats suitable for MMSC communications and/or processing. In an alternative implementation, an MMSC may be integrated within a Distributor system.

In one implementation, the Distributor controller 205 may further be coupled to one or more retailers 240, who may store, process, update, and/or distribute coupon data, sale data, promotional data, product catalogs, and/or the like. Retailers 240 may be communicatively coupled to one or more retailer databases 245 in which coupon data may be stored. The Distributor controller may engage, access, and/or communicate with the retailers 240 via a retailer interface 235, which may serve to configure coupon data received from retailers into one or more formats suitable for Distributor processing and/or storage, and/or for provision to an MMSC 230 for subsequent distribution to subscribers.

In one implementation, the Distributor controller 205 may further be coupled to a plurality of modules configured to implement Distributor functionality and/or services. A subscription management module 250 may, in various implementations, process subscriber subscription settings, requests, preferences, and/or the like; generate and store subscriber profiles, subscription data records, and/or the like; query subscriber profiles to extract subscription information and/or periodically query retailers for coupon updates; and/or the like. A communications module 255 may, in various implementations, configure communications, requests, queries, retailer coupon data, MMSC instructions, coupon alerts, and/or the like into one or more formats suited to the destination for and/or source of a particular communication.

In one implementation, the Distributor controller 205 may further be coupled to a plurality of databases configured to store and maintain Distributor data. A subscribers database 260 may contain subscriber profile information, coupon and/or alert preferences, mobile device specifications, current subscriptions, past coupon provisions and/or historical subscription records, and/or the like. A retailers database 265 may contain retailer profile information, coupon data, sale data, promotional data, coupon restrictions, cell phone company agreements and/or value exchanges, and/or the like. A coupons database 270 may contain coupon data configured as raw data, coupon formats and/or mobile device message formats (e.g., SMS text messages, MMS picture alerts, and/or the like).

In one embodiment, the Distributor controller 205 may be housed separately from other modules and/or databases within the Distributor, while in another embodiment, some or all of the other modules and/or databases may be housed within and/or configured as part of the Distributor controller. Further detail regarding implementations of Distributor controller operation, modules, and databases is provided below.

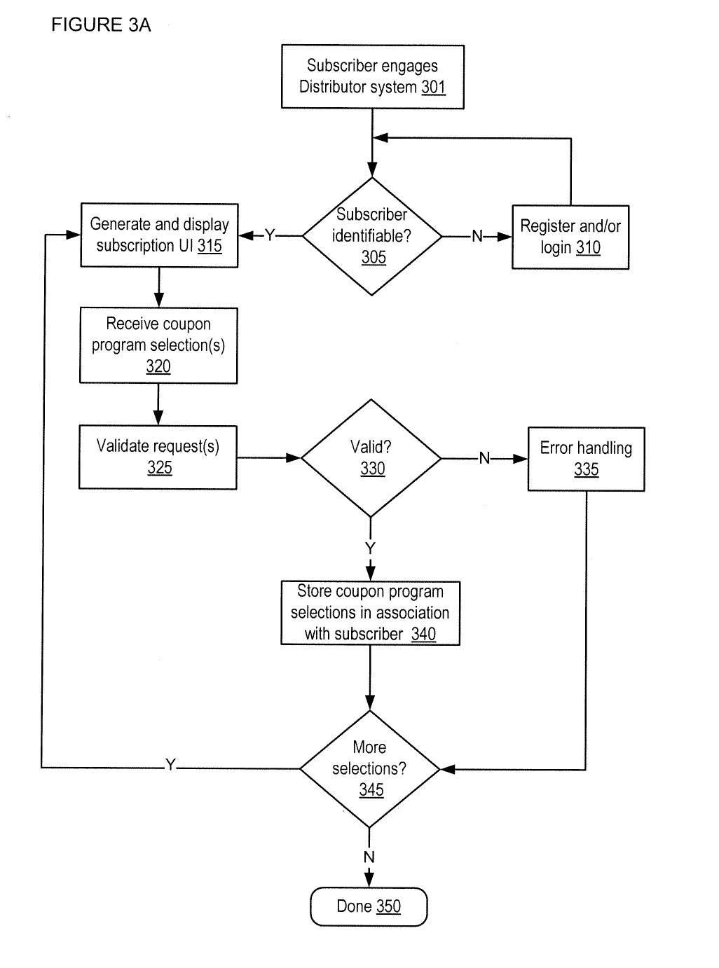

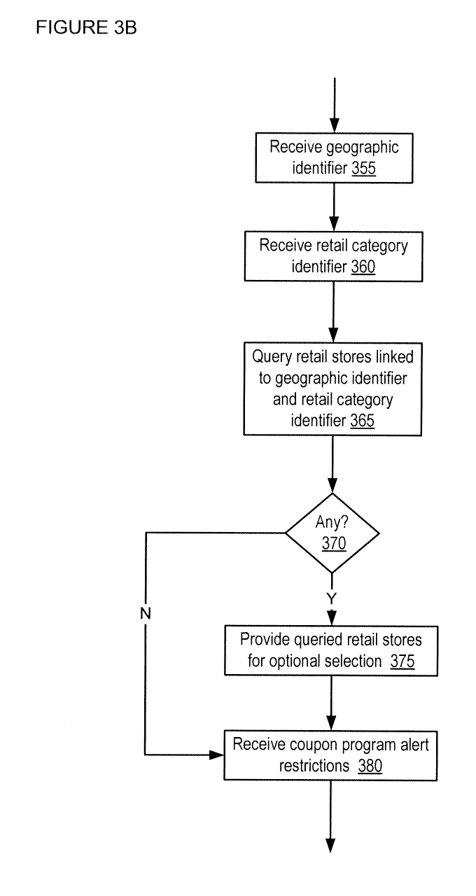

FIGS. 3A-3B show an implementation of logic flow for user coupon subscription in one embodiment of Distributor operation. In FIG. 3A, a subscriber may engage the Distributor system, such as via a web form on a website as accessed from a personal computer 301. In an alternative implementation, the subscriber may engage subscription components of the Distributor system via mobile device web software, mobile device messaging protocols (e.g., SMS, MMS, and/or the like), and/or the like. A determination may be made at 305 as to whether the subscriber is identifiable (e.g., whether the subscriber has registered and/or logged in with the Distributor system). If not, then the subscriber may be requested and/or required to register, log in, and/or the like in order to access further Distributor features and/or functionality 310. Once the subscriber is identifiable, the distributor may generate and/or display a subscription user interface (UI) to the subscriber 315. The subscription UI may include a variety of interface elements configured to receive information about subscriber and/or subscriber device characteristics and/or preferences, retailer selections, product selections, and/or the like to assist the Distributor in selecting and distributing coupons to one or more subscriber mobile devices. The subscriber's coupon program selections are received via the subscription UI 320, and the Distributor may, in one implementation, undertake a validation process for those selections 325. In one implementation, a validation process may comprise soliciting a confirmation from a participating retailer that the retailer is still engaged in and/or honoring a particular coupon program. In another implementation, a validation process may comprise comparing subscriber and/or subscriber device characteristics, preferences, and/or the like with requirements associated with selected retailers, coupons, coupon programs, and/or the like to determine whether any incompatibilities exist. A determination is made at 330 as to whether the coupon program selections are valid and, if not, then an error handling process may be undertaken 335. For example, in one implementation, an error handling process may present the user with an error message and initiate re-display of the subscription UI to allow the user to re-enter coupon program subscription parameters and/or preferences. If the coupon program selections are determined at 330 to be valid, then the program selections may be stored in association with the subscriber and/or a subscriber identifier in a database. A determination may then be made as to whether any more coupon subscriptions are to be made 345. If so, the Distributor may re-display the subscription user interface 315 to receive further coupon program selections. Otherwise, the subscription process may be done 350.

In FIG. 3B, further detail is shown in one embodiment of coupon program selection receipt (e.g., see 320 in FIG. 3A). In this embodiment, the Distributor may request and/or receive geographic identifier information 355, such as but not limited to a residential address, postal address, city, state, country, ZIP code, latitude, longitude, global positioning system (GPS) coordinates, and/or the like. In one implementation, the geographic identifier may refer to a subscriber's domicile, primary living area, primary shopping area, and/or the like. In one implementation, the geographic information may be sent directly from a GPS-enabled mobile device. In one implementation, a subscriber may only be permitted to enter geographic identifier information relevant to one location, while in an alternative implementation, the subscriber may be permitted to enter geographic identifier information relevant to a plurality of locations. The Distributor may also request and/or receive one or more retail category identifiers 360, such as but not limited to a retailer type (e.g., hardware stores, department stores, restaurants, online stores, service providers, and/or the like), retailer name, price category (e.g., high-end, bargain, price range specific, etc.), and/or the like. Based on the geographic identifier and/or the retail category identifier, the Distributor may then query a database of retail stores corresponding to the one or more geographic identifiers and/or the one or more retail category identifiers 365. For example, in one implementation, the Distributor may search through retail store records to find any records containing geographic and/or retail category fields matching identifiers received at 355 and/or 360. A retail store record may, for example, have a particular value for a geographic and retail category field if the store is respectively in or near that geographic location and of that retail category. A determination is made at 370 as to whether any of the retail store records in one or more queried databases match the received geographic and/or retail category identifiers. In one implementation, a tiered determination may be made, whereby the Distributor first checks whether matching retail store records exist for both geographic identifier and retail category identifier and, if not, then searches for one or the other identifier. In another implementation, a subscriber may be permitted to submit geographic identifiers and/or retail category identifiers at 355 and 360 that are ranked by priority. Such priority rankings may then determine the order with which a tiered determination may be performed at 370. If one or more matching retail store records are found, then the Distributor may provide a listing of the queried retail stores for display to the subscriber, such as via the subscription UI 375. In one implementation, the subscriber may be permitted to select one or more of the displayed retail stores, and a store identifier, retailer identifier, and/or the like may be stored in association with the subscriber identifier. The Distributor may further request and/or receive one or more coupon program alert restrictions 380, specifying conditions, restrictions, limitations, and/or the like on delivery of coupons to a mobile device. For example, in one implementation, a subscriber may specify a blackout period comprising a one-time or recurring time period during which no coupon alerts, messages, and/or the like are to be sent to the subscriber's mobile device. In another implementation, a subscriber may specify a maximum number of coupons he or she wishes to receive within any given time period. A wide variety of other alert restrictions may be specified and/or applied within various implementations.

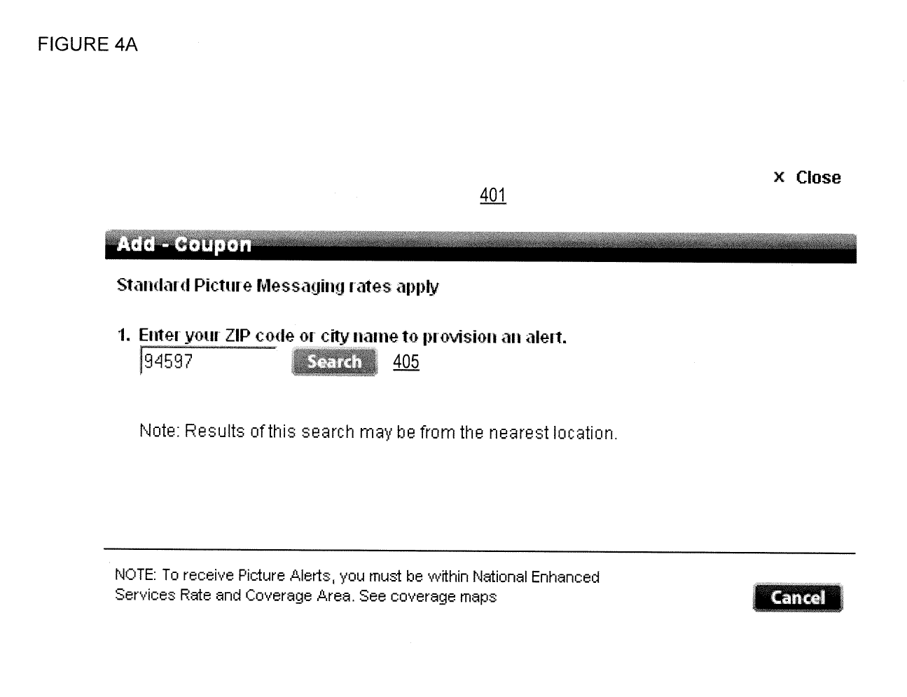

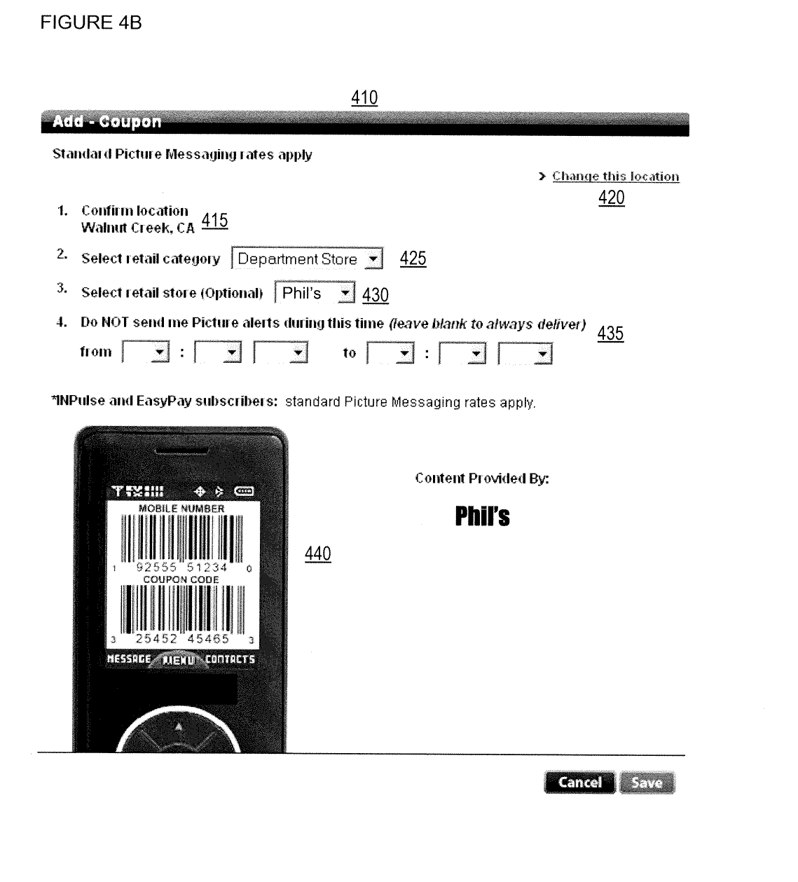

FIGS. 4A-4B show aspects of an implementation of a user interface for user coupon subscription in one embodiment of Distributor operation. In FIG. 4A, an implementation of a first page of a subscription UI is shown 401, including a field 405 configured to receive geographic identifier information. The illustrated implementation comprises a text box in which a ZIP code or city name may be entered. In alternative implementations, a user may specify a geographic identifier by clicking on a map, entering an address, sending a set of geographic coordinates from a location-sensitive mobile device, and/or the like. In FIG. 4B, an implementation of a second page of a subscription UI is shown 410. The page includes a confirmation display of a geographic location specified by the geographic identifier supplied at 405 in FIG. 4A. The page also includes a link to change the location 420, which may return the subscriber to the page shown in FIG. 4A. The Distributor may further display one or more selectable retail categories 425, such as via the pull-down menu shown in the illustrated implementation, or via any other suitable interface element. In one implementation, the selection of retail categories for display at 425 may depend on the one or more geographic identifiers specified at 405 and/or displayed at 415. For example, the Distributor may query a database of retail categories based on the one or more geographic identifiers in order to determine which, if any, retail categories correspond to and/or are associated with any of the one or more geographic identifiers. The page 410 may further include one or more interface elements configured to receive coupon program selections corresponding to specific retail stores 430. In one implementation, the selection of retail stores for display to the subscriber may depend on the at least one geographic identifier and/or the at least one retail category specification. The page 410 may further include one or more interface elements configured to receive specifications of coupon alert restrictions 435. In the illustrated implementation, pull-down menus are shown allowing a subscriber to specify blackout periods comprising periods of time during which the Distributor is not to send coupon alerts to the subscriber's mobile device. The page 410 may further include a preview 440 of how a coupon may appear to inform the subscriber what to expect and/or to instruct him or her on how to redeem the coupon at the point of sale.

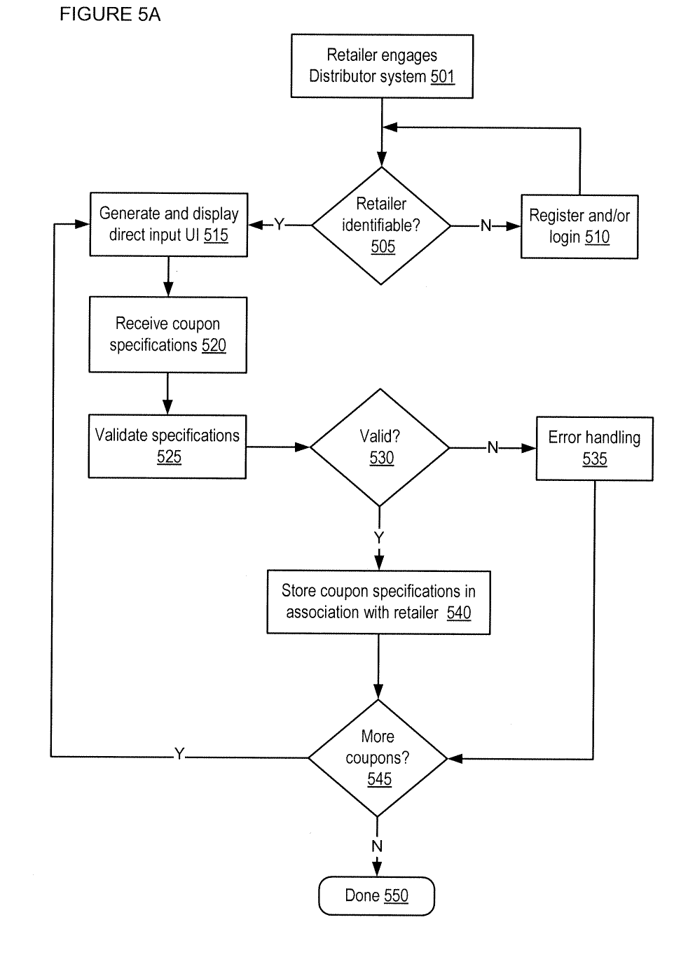

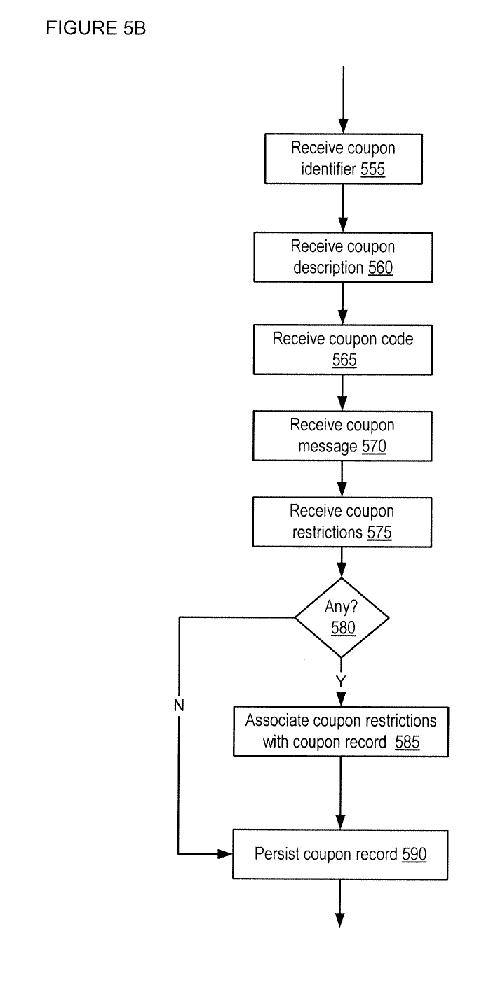

FIGS. 5A-5B show an implementation of logic flow for retailer coupon generation in one embodiment of Distributor operation. A retailer may engage a Distributor system at 501 to provide coupon information, such as via a direct input UI. A determination may be made at 505 as to whether or not the retailer is identifiable. For example, a Distributor system may check whether a retailer is registered, has logged in, is engaging the Distributor system from a recognized computer terminal, and/or the like. If the retailer is not identifiable, then the Distributor may request that the retailer register and/or log in 510 prior to allowing the retailer to continue and/or to access the direct input UI. If the retailer is identifiable at 505, then the Distributor may generate and/or display the direct input UI 515 to the retailer and receive, thereby, retailer coupon specifications 520. A wide variety of coupon specifications may be compatible with Distributor operation. In one implementation, coupon specifications may comprise a coupon name, a coupon code, a description, an image, terms, conditions, and/or the like. In one implementation, coupon specifications may further comprise restrictions, such as but not limited to: a forward lock, restricting the ability of a coupon recipient to forward the coupon to a third party; timing restrictions, restricting the dates, times of day, and/or the like when a coupon may be redeemed; location restrictions, restricting the geographic areas, store locations, and/or the like at which a coupon may be redeemed; and/or the like. A forward lock may be implemented, for example, by configuring a coupon code to only work in conjunction with a subscriber and/or subscriber hardware identifier. Redemption of a forward-locked coupon may, for example, require input of both a coupon code and a matching hardware code in order to administer the expected coupon benefit at the point-of-sale.

In one implementation, coupon specifications may further include a coupon benefit specification and/or formula based on which the Distributor may determine subscriber-tailored benefits and/or supply subscriber information to a point-of-sale computer terminal to allow it to determine subscriber-tailored benefits at the point-of-sale. In one implementation a coupon benefit may depend on how many unused cell phone minutes a particular subscriber has at a given time during the month. For example, a subscriber may be receive a greater coupon benefit in exchange for trading in unused minutes. In another example, a user may receive a greater coupon benefit if the subscriber has gone over his or her anytime minutes for the month. In one implementation, the amount of benefit tied to cell phone minutes may depend on an agreement between a retailer and a cell phone company and/or on an exchange of value therebetween. In another implementation, a coupon benefit may depend on historical data concerning subscriber reliability in paying a cell phone bill. For example, a subscriber who has reliably paid a cell phone bill over a predetermined number of billing cycles may receive a greater coupon benefit than a subscriber who has been delinquent in bill payments. The amount of the increased benefit may again, in one implementation, depend on a prior agreement and/or exchange of value between a cell phone company and a retailer. In another implementation, coupon types and/or discount and/or benefit amounts may be based on subscriber mobile device type, such as may be discerned from a subscriber hardware identifier. In another implementation, coupon benefits may depend on an associated rewards program. For example, a subscriber may be permitted to exchange frequent flyer points and/or points from any other reward system for increased discounts and/or other coupon benefits. In other implementations, other incentive programs and/or subscriber-tailoring procedures may be undertaken.

In one implementation, the types of coupons provided to subscribers, in addition to the amount of benefit associated therewith, may also be tailored to be subscriber specific. For example, each coupon record may specify subscriber criteria which the Distributor may check when determining whether or not to send a particular coupon to a particular subscriber. For example, a coupon may specify that only subscribers having a particular mobile device should receive a coupon applicable to accessories for that device. In another example, a coupon may specify that only subscribers meeting particular demographic criteria should receive a particular coupon. Subscribers may be requested to provide demographic information when registering for Distributor services and/or when attempting to subscribe for a coupon, retailer, retail category, and/or the like where such information may be relevant to coupon distribution. In still another implementation, the Distributor may track subscriber behavior, such as coupons redeemed by the subscriber, and save behavioral information in a subscriber profile. Subsequent selection of coupons for distribution may then be based in part on stored behavioral information associated with the subscriber. For example, a given subscriber who has subscribed to fast food coupons may be observed to frequently redeem coupons for milkshakes but never for french fries. The Distributor may subsequently direct Distributor and/or retailer system components to favor milkshake coupons and disfavor french fry coupons for the particular subscriber. In one implementation, favoring and disfavoring of coupon types for given subscribers may be achieved by assigning a score to each coupon type based on subscriber behavior (e.g., incrementing a coupon type score every time a coupon of a particular type is redeemed) and querying scores each time a coupon is being considered for distribution, only sending coupons corresponding to high coupon type scores in the subscriber profile.

Once coupon specifications are received, the Distributor may, in one implementation, undertake a validation of the coupon specifications 525. A wide variety of validation methods and/or procedures may be undertaken in different implementations and embodiments of Distributor operation. For example, in one implementation, coupon specification validation may comprise issuing a query to a retailer server based on the supplied coupon code to check if the code is valid and/or that the code corresponds to an associated benefit. In another implementation, coupon specification validation may comprise a spell and/or grammar check on the coupon description. In another implementation, coupon specification validation may comprise a test-scan of a supplied barcode, matrix code, and/or the like. In another implementation, coupon specification validation may comprise checking for a prior agreement and/or exchange of value between a cell phone company and a retailer for a coupon specification tying coupon benefits to a subscriber's cell phone usage, bill payment history, and/or the like. Based on the Distributor's coupon specification validation, a determination is made at 530 as to whether the retailer supplied coupon specifications are valid. If not, then an error handling routine may be engaged 535, such as by supplying an error message to the retailer, re-displaying the direct input UI for correction of errors in coupon specification, and/or the like. If coupon specifications are deemed valid at 530, then the Distributor may store coupon specifications in association with the retailer 540. A determination may be made at 545 as to whether there are any more coupons that the retailer wishes to enter. If so, then the Distributor returns to 515 to present the retailer with the direct input UI. Otherwise, the coupon specification session is done 550.

In some implementations, retailers may be allowed to edit aspects of coupon specifications at various times subsequent to coupon creation. In one implementation, a retailer may be permitted to edit any part of a coupon at any time after coupon creation, and such edits are reflected in coupons subsequently supplied to coupon subscribers. In another implementation, a retailer may only be permitted to edit select coupon specifications subsequent to coupon creation (e.g., only aesthetic coupon elements, such as name or associated image, and not any coupon elements that would affect the point-of-sale benefit). In another implementation, a retailer may be permitted to edit coupon specifications only for a certain period of time (e.g., 3 days after coupon creation) or prior to the occurrence of an event (e.g., the provision of a coupon to a subscriber). In another implementation, no edits are allowed to a coupon subsequent to coupon creation. A retailer may, however, be allowed to cancel a coupon in some implementations.

In FIG. 5B, further detail is shown for receiving coupon specifications in one embodiment of Distributor operation. The Distributor may receive a coupon identifier, such as a coupon name, identifier code, symbol, and/or the like 555. The Distributor may further receive a coupon description 560, such as may specify coupon benefits, terms, restrictions, and/or the like and/or otherwise serve to describe the coupon. The Distributor may further receive a coupon code 565, configured to authorize administration of the coupon benefit for a particular purchase. In various implementations, the coupon code may comprise an alphanumeric string, a bar code, a matrix code, and/or the like. The Distributor may further receive a coupon message 570 to be received by a subscriber alongside the coupon itself and, for example, describing an associated coupon benefit, terms, conditions, restrictions, and/or the like to direct a coupon recipient in redeeming the coupon and/or a point-of-sale employee in administering the associated benefit. The Distributor may further receive one or more coupon restrictions 575 such as but not limited to: a forward lock, restricting the ability of a coupon recipient to forward the coupon to a third party; timing restrictions, restricting the dates, times of day, and/or the like when a coupon may be redeemed; location restrictions, restricting the geographic areas, store locations, and/or the like at which a coupon may be redeemed; number restrictions, restricting the total number, number per period, and/or the like of coupons that may be redeemed and/or honored; expiration restrictions, specifying a time after which a coupon may no longer be valid; and/or the like. A forward lock may be implemented, for example, by configuring a coupon code to only work in conjunction with a subscriber and/or subscriber hardware identifier. Redemption of a forward-locked coupon may, for example, require input of both a coupon code and a matching hardware code in order to administer the expected coupon benefit at the point-of-sale. A determination may be made at 580 as to whether any coupon restrictions have been specified. If so, then the restrictions are associated with the coupon record 585. Finally, the Distributor may persist the coupon record 590 for subsequent storage or use.

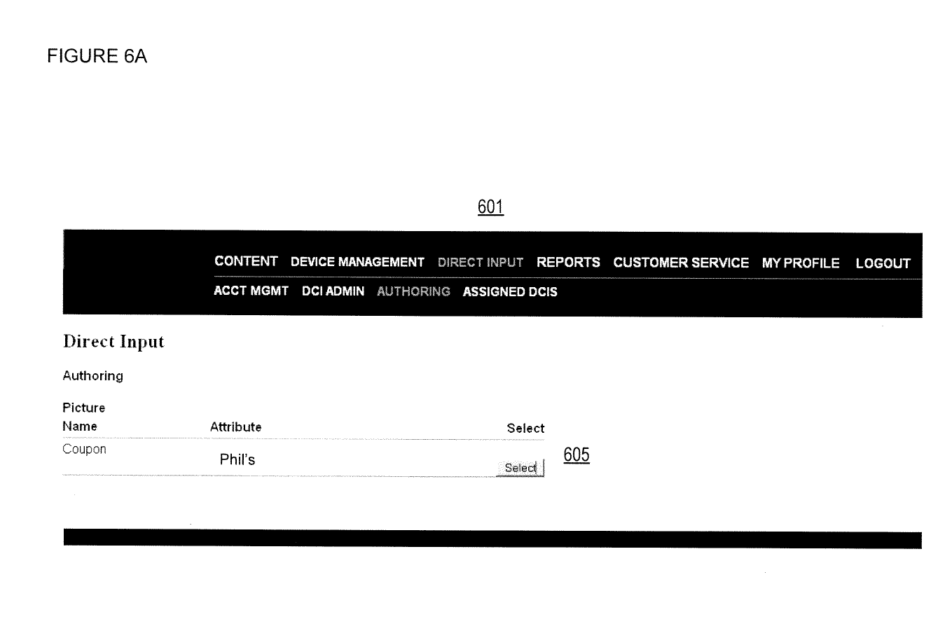

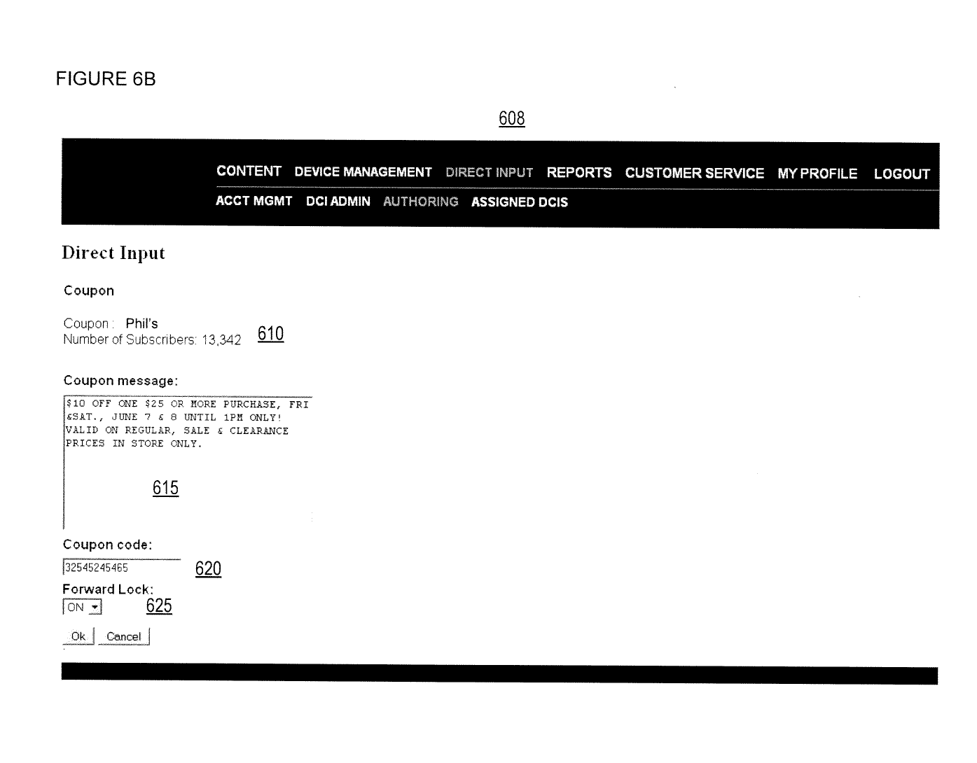

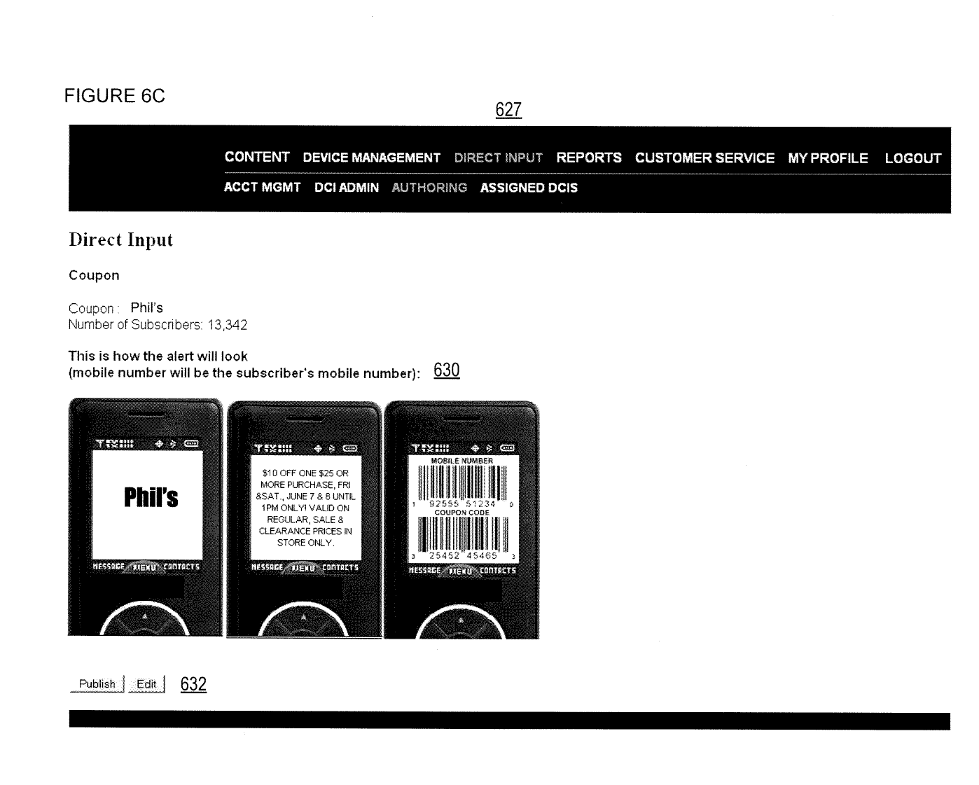

FIGS. 6A-6C show aspects of an implementation of a user interface for retailer coupon generation in one embodiment of Distributor operation. The retailer coupon generation UI, or direct input UI, may, in one implementation, comprise a plurality of screens for administering and/or engaging various aspects of the coupon generation process. In FIG. 6A, a first screen 601 is shown, allowing a retailer to specify coupon identifier information and/or select an existing coupon record 605. In FIG. 6B, a second screen 608 is shown. The second screen includes a coupon name and number of subscribers at 610. The number of subscribers may, in one implementation, indicate the number of subscribers to which the specific coupon has been distributed. In another implementation, the number of subscribers may indicate the number that have subscribed to receive coupons from the retailer associated with the specific coupon. In still another implementation, the number of subscribers may indicate the number eligible to receive the specific coupon. The page further includes text boxes configured to receive and/or display a coupon message 615 and a coupon code 620. In one implementation, the coupon code specified by the retailer comprises an alphanumeric string, based on which the Distributor may generate one or more barcodes, data matrices, and/or the like. In another implementation, the Distributor may receive barcodes, data matrices, and/or the like directly from the retailer, such as by providing a file dialog requesting an image file upload from the retailer. The page further includes an interface element configured to receive a coupon restriction, specifically a forward lock setting 625. In FIG. 6C, a third page is shown 627 displaying a representation of the coupon as it may appear to a subscriber receiving the coupon on a mobile device 630. The retailer, having inspected the coupon at 630, may then be permitted to edit the coupon or publish it so that it may be provided to subscriber mobile devices by the Distributor 632.

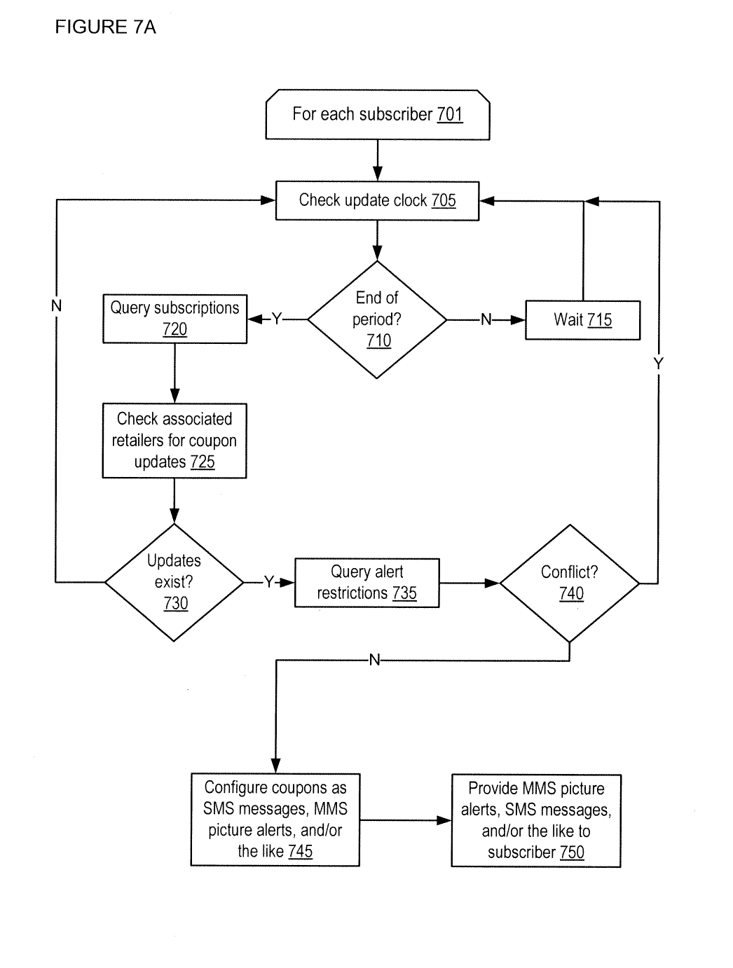

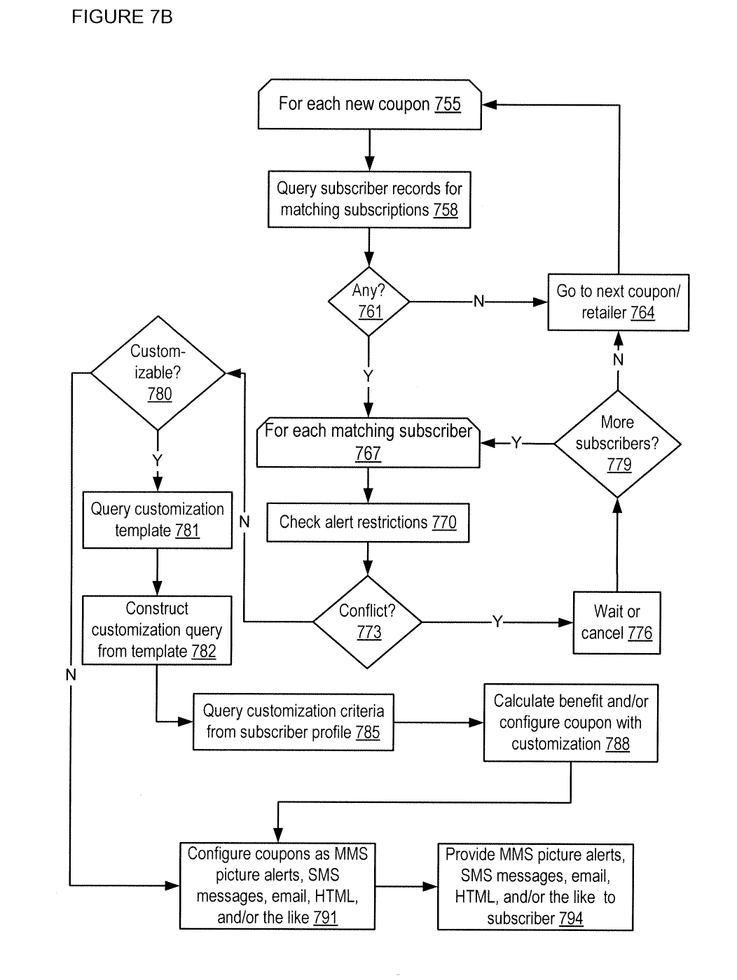

FIGS. 7A-7B show two implementations of logic flow for coupon delivery to mobile devices in embodiments of Distributor operation. In FIG. 7A, for each subscriber 701, the Distributor may check an update clock 705 to determine whether or not an end of period has occurred 710 at which time a coupon is to be provided to the subscriber's mobile device. If not, then the Distributor may wait for a designated period of time 715 before checking the update clock again 705. When an end of period has been reached, the Distributor may query subscriptions corresponding to and/or associated with the subscriber and/or a subscriber identifier, profile, and/or the like 720 and check if any retailers associated with those subscriptions have coupon updates 725. A determination is made at 730 as to whether any such updates exist and, if not, then the Distributor may return to 705 to begin a new update clock cycle. If, however, updates are found, then the Distributor may query alert restrictions 735. Alert restrictions may comprise subscriber-specified alert restrictions and/or retailer-specified alert restrictions. A determination is made at 740 as to whether there are any conflicts with the alert restrictions, if any, queried at 735. For example, the Distributor may check whether the current time of day corresponds to a blackout period specified by the subscriber during which he or she does not wish to receive any coupon alerts. If a conflict exists, then the Distributor may return to 705 to begin a new update cycle. Alternatively, the Distributor may wait for a period of time before rechecking for conflicts. When no conflicts exist, the Distributor may configure the coupon as a mobile device message, such as an SMS text message, an MMS picture alert, and/or the like 745. The mobile device message may then be provided to the subscriber and/or a subscriber mobile device 750. In some implementations, a messaging fee may be levied for coupon alerts provided to subscriber mobile devices. For example, in one implementation, a per-coupon fee may be levied each time a subscriber receives a coupon. In another implementation, a subscriber may pay a one-time and/or periodic fee for the privilege of receiving coupon alerts freely. In still another implementation, retailers may pay fees on a per-coupon or periodic basis for the privilege of having their coupons provided to subscribers.

FIG. 7B shows an alternative implementation, including subscriber-specific coupon customization functionality. For each new coupon 755, the Distributor may query subscriber records for subscriptions matching the coupon and/or an associated retailer, retail category, and/or the like 758. A determination is made at 761 as to whether or not any matches exist and, if not, then the Distributor may go to the next coupon, retailer, retail category, and/or the like 764. If a match exists at 761, then for each matching subscriber 767, the Distributor may check alert restrictions associated with the subscriber 770. If a conflict exists with respect to any existing alert restrictions 773, then the Distributor may wait (e.g., for a time based alert restriction) and/or cancel the coupon for the particular user 776. The Distributor may then determine whether additional users are to be checked 779 and, if so, then the Distributor may return to 767. If no further users remain, the Distributor may cycle to the next coupon, retailer, retail category, etc 764. If no conflicts exist at 773, the Distributor may determine whether the coupon is of a type that is customizable for specific subscribers 780. If so, the Distributor may query a coupon customization template associated with the coupon, such as from a coupon and/or customization template database 781. A coupon customization template may define one or more fields that determine how a coupon is to be customized. For example, a customizable coupon may depend on a subscriber's cell phone bill payment history and coupon redemption history. The corresponding coupon customization template in this example may, then, include fields for a bill payment history metric and a coupon redemption history metric. Based on the coupon customization template, the Distributor may construct a customization criteria query 782 comprising fields from the customization template. The constructed query is used to query customization criteria, comprising information pertinent to the customization of the coupon as instructed by the customization template, such as from a subscriber profile 785. In various implementations, other information sources may be queried in addition to or instead of a subscriber profile, such as but not limited to a retailer database, a cell phone company database, a marketing database, and/or the like. The Distributor may calculate a coupon-associated benefit and/or configure the coupon and/or a coupon benefit based on the customization criteria 788. A completed coupon may be configured as a mobile device message, such as an SMS text message, an MMS picture alert, an e-mail, a hypertext markup language (HTML) link, and/or the like 791, and the mobile device message may then be provided to the subscriber and/or a subscriber mobile device 794.

In an alternative implementation, the Distributor may provide the same coupon to each subscriber, but implement subscriber-specific customization of administered benefits at the point-of-sale. This may be accomplished, for example, by receiving a subscriber and/or subscriber hardware identifier alongside a coupon code at the point-of-sale, querying a subscriber record based on the subscriber and/or subscriber hardware identifier, and determining a customized benefit based on elements of the subscriber record in conjunction with coupon information associated with the coupon code.

In one implementation, coupon alerts may be configured as data feeds (e.g., RSS feeds), to which subscribers may subscribe by linking to an identifier for a particular feed via a feed reader and/or aggregator. More details surrounding configuring coupons as data feeds is provided below.

In one implementation, the method, protocol, format, and/or the like by which a coupon is delivered to a particular subscriber and/or subscriber mobile device is determined, at least in part, by subscriber and/or subscriber hardware specific information. For example, the Distributor may query a subscriber's mobile device type, data plan, preference settings, and/or the like and, based on that query, select one or more formats, such as SMS text messages, MMS picture alerts, e-mails, HTML links, data feeds, and/or the like for supplying a particular coupon.

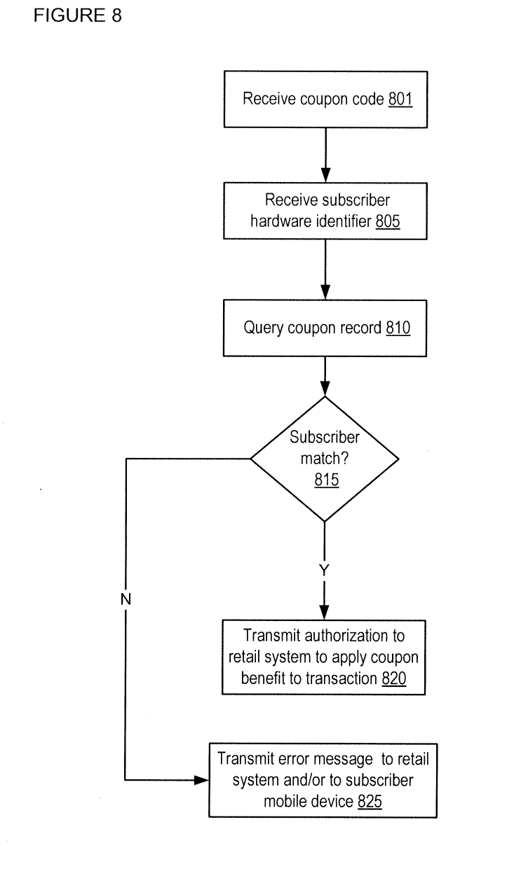

FIG. 8 shows an implementation of logic flow for coupon authentication in one embodiment of Distributor operation. In one implementation, coupon authentication may be undertaken by the Distributor and/or Distributor components. In an alternative implementation, coupon authentication may be undertaken by a retailer system. A coupon code is received at 801. For example, a coupon code configured as a barcode may be scanned at a point of sale, and the extracted coupon code information sent via a communications network to an authentication system. A subscriber hardware identifier may also be received 805. The subscriber hardware identifier may comprise a subscriber code associated with a subscriber's mobile device, such as a service-subscriber key, international mobile subscriber identity, and/or the like. The subscriber code may, in one implementation, be configured as a scannable barcode to be scanned in conjunction with the coupon barcode. In an alternative implementation, the subscriber code may comprise an alphanumeric string that is keyed in at the point of sale. In still another implementation, a subscriber code may not be subscriber hardware specific, but rather specific to a given subscriber, such as a username or password, and the coupon code may be configured to unlock its benefit upon entry of the subscriber specific code at the point-of-sale. A coupon record may be queried at 810 in order to determine whether there is a match between the coupon code and the subscriber hardware identifier 815 (e.g., whether or not the coupon code operates in conjunction with the subscriber hardware identifier to yield a benefit associated with the coupon). If so, then an authorization to apply the coupon benefit to the transaction at hand may be transmitted to a retail point-of-sale system 820. Otherwise, an error message may be transmitted to the retail system and/or to a subscriber's mobile device indicating failure of authentication and the inability to apply the coupon benefit to the transaction 825.

In an alternative implementation, discouraging sharing of coupon codes may be achieved by setting a coupon code expiration criterion. For example, a coupon code may be set to expire after use. When the coupon code is engaged at the point-of-sale and a benefit conferred on the transaction, a message may be relayed to a Distributor system component, retailer system component, and/or the like to cancel the coupon code and/or to mark the code as no longer valid.

### Mobile Device Data Feeds

This section describes embodiments of the Distributor wherein coupons and/or associated information may be embodied as data feeds, such as RSS feeds, that are delivered to mobile devices. Data feeds, such as web feeds, RSS feeds, Atom feeds, and/or the like, are among the most popular means of acquiring news and/or information from the internet, in particular from the world wide web. Data feeds allow users the freedom to select for and distill the content that is most informative and/or interesting for them. Distributor embodiments may serve to facilitate users' selection of data feeds of interest and the provision of data feed data to mobile devices. In one embodiment, the Distributor may acquire and/or validate user preferences with respect to available data feeds, store those preferences, and subsequently direct the provision of data feed updates to a user's mobile device via short message service (SMS) text messages, multimedia messaging service (MMS) picture alerts, and/or the like. A wide variety of mobile devices may be compatible with Distributor services, such as but not limited to mobile telephones, personal digital assistants (PDAs), blackberries, iPhones, iPod Touches, and/or the like. It is to be understood that, depending on the particular needs and/or characteristics of a Distributor user, administrator, content provider, data payload, monetization model, hardware configuration, network framework, and/or the like, various embodiments of the Distributor may be implemented that enable a great deal of flexibility and customization. The instant disclosure discusses embodiments of the Distributor primarily within the context of voluntary RSS feed subscriptions and data display on personal mobile devices. However, it is to be understood that the system described herein may be readily configured/customized for a wide range of other applications or implementations. For example, aspects of the Distributor may be adapted for emergency alert distribution, personal reminders, non-mobile data display platforms, and/or the like applications. It is to be understood that the Distributor may be further adapted to other implementations or data distribution applications.

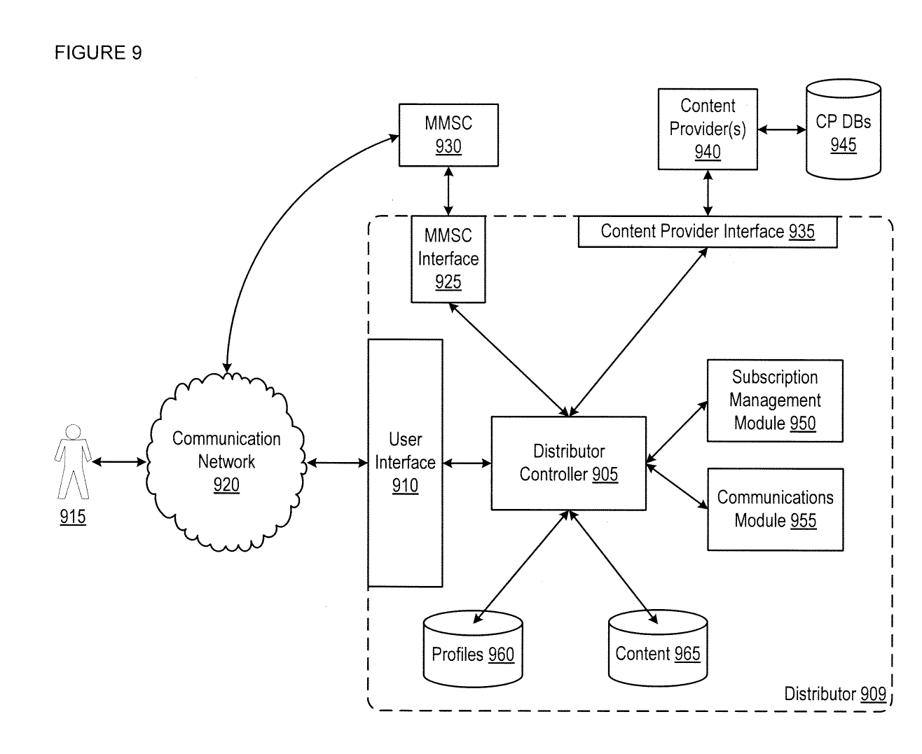

FIG. 9 provides an overview of an implementation of Distributor components and affiliated entities in one embodiment of Distributor operation. The Distributor 901 may contain a number of functional modules and/or data stores. A Distributor controller 905 may serve a central role in some embodiments of Distributor operation, serving to orchestrate the reception, generation, and distribution of data and/or instructions to, from and between Distributor modules and/or mediate communications with external entities and systems. An external user 915, who may be equipped with a communications enabled computing terminal and/or mobile device, may access Distributor services via a communications network 920. A Distributor user interface 910 may be configured to receive user subscription requests, specifications, and/or instructions, relay Distributor messages and/or content provider data, and/or the like.

In one implementation, the Distributor controller 905 may further be coupled to a MMS Center (MMSC) 930, equipped to process received data into one or more MMS messages, picture alerts, and/or the like and to send generated messages to any of a variety of destinations, mobile devices, and/or the like, such as to a user's 915 mobile device via a communications network 920. The Distributor controller may engage, access and/or communicate with the MMSC 930 via an MMSC interface 925, which may serve to configure data provided to the MMSC into one or more formats suitable for MMSC communications and/or processing. In an alternative implementation, an MMSC may be integrated within a Distributor system.

In one implementation, the Distributor controller 905 may further be coupled to one or more content providers 940, who may store, process, update, and/or distribute content data pertaining to a wide variety of different subjects of interest. By way of example only, content providers may comprise news services, blogs, podcasters, schools, emergency services, weather agencies, entertainment broadcasters, and/or the like. A content providers 940 may be communicatively coupled to one or more content provider databases 945 in which content data is stored. The Distributor controller may engage, access, and/or communicate with the content providers 940 via a content provider interface 935, which may serve to configure data received from content providers into one or more formats suitable for Distributor processing and/or storage, and/or for provision to an MMSC 930 for subsequent distribution to users.

In one implementation, the Distributor controller 905 may further be coupled to a plurality of modules configured to implement Distributor functionality and/or services. A subscription management module 950 may, in various implementations, process user subscription settings, requests, preferences, and/or the like; generate and store user profiles, subscription data records, and/or the like; query user profiles to extract subscription information and/or periodically query content providers for data feed updates; and/or the like. A communications module 955 may, in various implementations, configure communications, requests, queries, content provider data, MMSC instructions, user alerts, and/or the like into one or more formats suited to the destination for and/or source of a particular communication.

In one implementation, the Distributor controller 905 may further be coupled to a plurality of databases configured to store and maintain Distributor data. A profiles database 960 may contain user profile information, data feed and/or alert preferences, mobile device specifications, current user subscriptions, past data feed provisions and/or historical subscription records, and/or the like. A content database 975 may contain content provider data configured as raw data, data feed formats and/or mobile device message formats (e.g., SMS text messages, MMS picture alerts, and/or the like).

In one embodiment, the Distributor controller 905 may be housed separately from other modules and/or databases within the Distributor, while in another embodiment, some or all of the other modules and/or databases may be housed within and/or configured as part of the Distributor controller. Further detail regarding implementations of Distributor controller operation, modules, and databases is provided below.

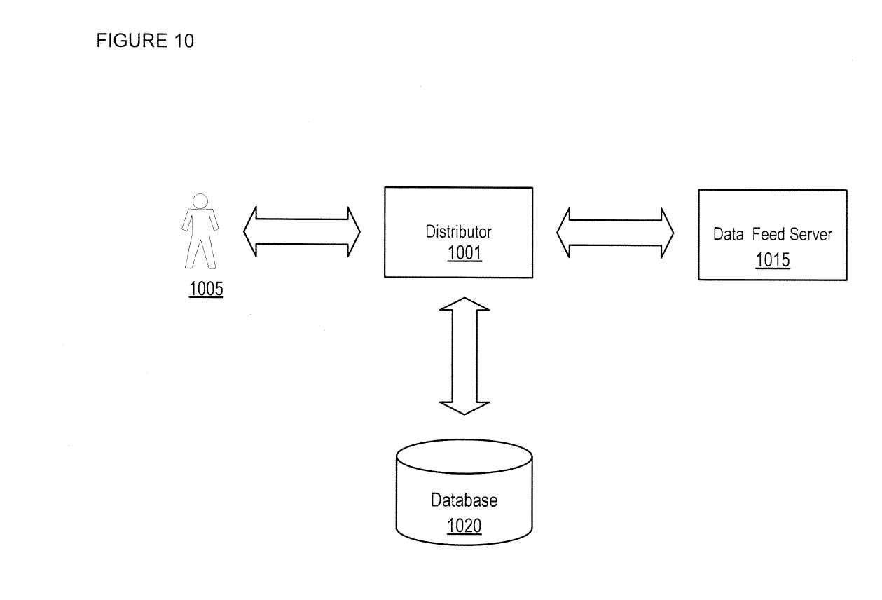

FIG. 10 shows an implementation of data flow for user feed subscription in one embodiment of Distributor operation. The Distributor 1001 may be coupled to one or more users 1005 who may provide and/or specify data feed information, preferences, settings, and/or the like, such as via a Distributor subscription provisioning page. In one implementation, the provisioning page may comprise a web form. In one implementation, the user may engage the provisioning page via a non-mobile computing terminal. In another implementation, the user may engage the provisioning page via a mobile device web browser. The data feed information provided by the user may comprise a data feed address designation. For example, the data feed may comprise an RSS feed, Atom feed, and/or the like, and the address designation may comprise a universal resource locator corresponding the data feed. The Distributor 1001 may send a request to the address designation in order to validate the data feed server 1015 and/or otherwise determine that a valid data feed is associated thereto. If the Distributor 1001 determines that the data feed information provided by the user corresponds to a valid data feed, then the Distributor may store and/or update the user's subscription information, comprising data feed information, preferences, settings, and/or the like, in a database 1020, such as a profiles database.

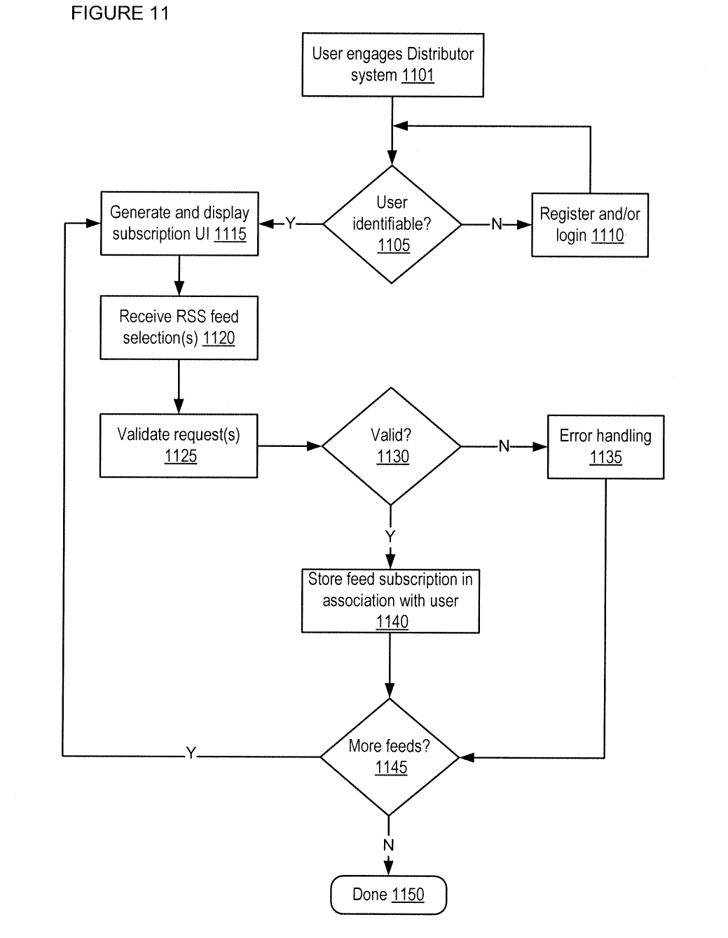

FIG. 11 shows an implementation of logic flow for user feed subscription in one embodiment of Distributor operation. A user may engage a distributor system at 1101, such as via a non-mobile computing terminal coupled to a communications network. In another implementation, the user may engage a Distributor system via a mobile device coupled to a communications network (e.g., via a mobile device web browser). A determination may be made at 1105 as to whether the user is identifiable (e.g., whether the user is registered, has logged in, whether the user's mobile device has provided a user identifier, and/or the like). If not, then the user may be requested to register and/or log in 1110 before allowing him or her to proceed with engaging other Distributor services and/or functionality. Once the Distributor is able to identify the user, a user interface (UI) comprising a subscription provisioning page may be generated and displayed 1115. In one implementation, the subscription provisioning page may comprise a web form, such as may contain fillable text boxes, selectable links, and/or any of a variety of other form elements, interface widgets, and/or the like. In one implementation, the web form may comprise a text box configured to receive data feed address designations and/or a list of selectable links corresponding to data feed sources. The Distributor may receive one or more data feed (e.g., RSS feed) selections at 1120, the selections comprising at least a data feed address designation. In one implementation, the data feed selections may further comprise messaging and/or alerting restrictions, such as an alert cap (e.g., a maximum number of data feed messages to be sent to the user in a pre-designated period of time), blackout periods (e.g., periods of time during which no data feed updates should be sent to the user's mobile device), and/or the like.

In one implementation, the Distributor may undertake validation of the user's data feed subscription request 1125. Validation may, for example, comprise sending a request for data to the data feed address designation (e.g., URL) specified by the user and determining whether a valid data feed corresponds thereto (e.g., by checking whether properly configured data is returned). A determination is made at 1130 as to whether or not the user's data feed subscription request is determined to be valid. If not, then an error handling procedure may be undertaken 1135. For example, the user may be provided with an error message, a request to check and/or re-enter the subscription request, a listing of system guesses for valid data feeds that are closest to the address designation provided by the user, and/or the like. If, on the other hand, the subscription request is determined to correspond to a valid data feed, then the feed subscription information and/or other information associated with the subscription request may be stored in association with the user, a user identifier, a user profile, and/or the like 1140. A determination may then be made as to whether the user desires to enter more feed subscription requests 1145. If so, the Distributor returns to 1115 to generate and/or display the subscription provisioning form. Otherwise, the user feed subscription flow is done 1150.

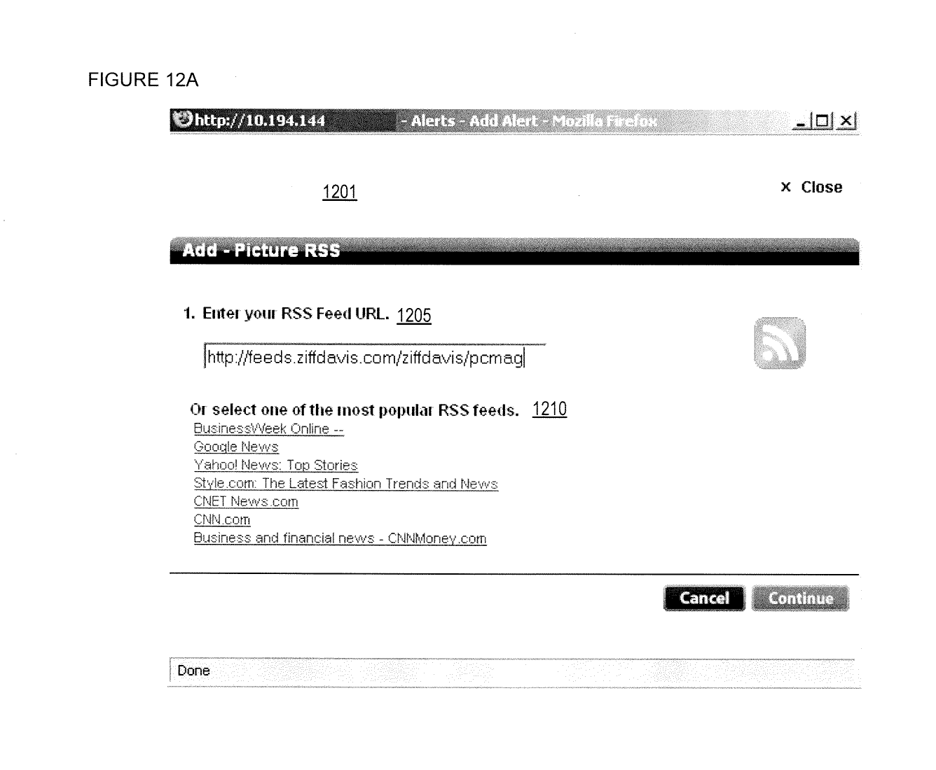

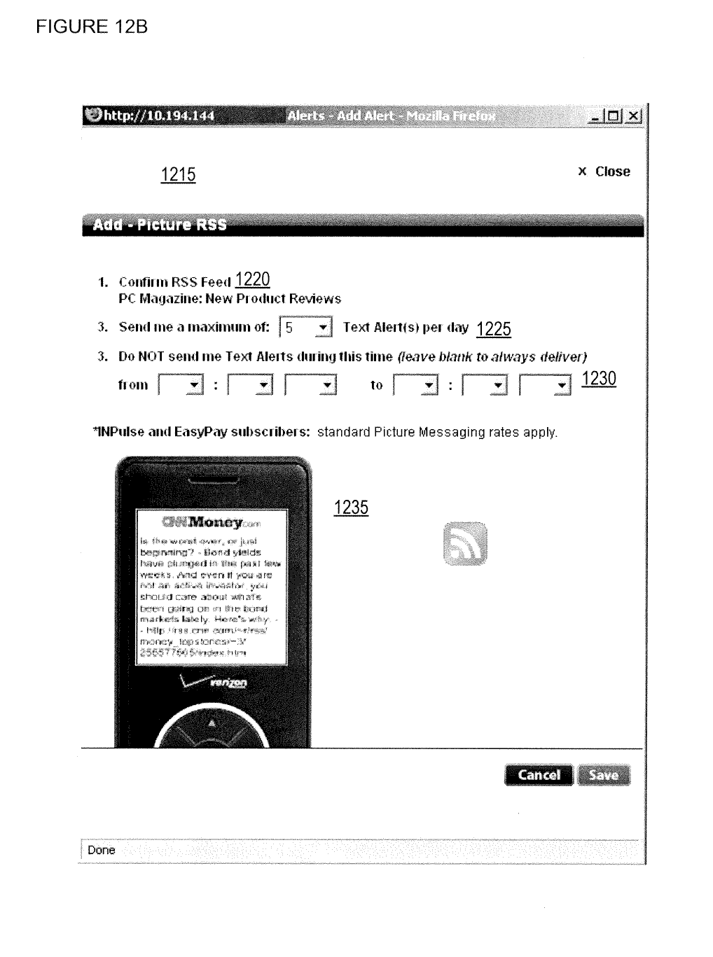

FIGS. 12A-12B show aspects of an implementation of a user interface for user feed subscription in one embodiment of Distributor operation. In FIG. 12A, aspects of a first page 1201 of the subscription provisioning page are shown in one implementation. The page includes an area 1205 that includes a text box configured to receive RSS feed URLs corresponding to RSS feeds to which the user wishes to subscribe. The page further includes an area 1210 listing popular RSS feeds. Each listing in the list of feeds is configured as a selectable link, whereby selection thereof instructs the Distributor to query and/or store an associated URL and/or other data feed address designation. In FIG. 12B, aspects of a second page 1215 of the subscription provisioning page are shown in one implementation. The page includes an area displaying one or more selected data feeds 1220, in this case displayed by an associated title. In one implementation, the display of selected data feeds may include an interactive widget configured to allow a user to specify whether the displayed data feed source corresponds to the desired data feed. If the user specifies that it does not, the Distributor may return the user to the first page shown at 1201 to re-enter data feed information. The page at 1215 further includes an area 1225 wherein a user may specify a data feed restriction comprising a messaging and/or alert cap. In the displayed implementation, the user is permitted to specify a maximum number of text alerts, corresponding to data feed updates, to be provided to his or her mobile device within a pre-designated period of time (e.g., one day). The page further includes a second area for specifying a data feed restriction 1230, in this case a blackout period during which the user does not wish to receive any messages and/or alerts associated with data feed updates. The interface elements for specifying the blackout period in the illustrated implementation comprise pull-down menus for specifying a start and end time for the blackout period, though a variety of other interface elements may be employed in alternative implementations. Finally, the illustrated implementation of the second provisioning page 1215 includes a display of an example alert sent to a mobile device 1235. In one implementation, the Distributor may query a latest data feed update associated to the data feed selected by the user for subscription (e.g., from the data feed source displayed at 1220) and display it in the example at 1235. In another implementation, the Distributor may query a user profile and extract a user's mobile device hardware identifier in order to determine what type of mobile device the user has. The Distributor may then retrieve an image associated with that mobile device and use it in the example display shown at 1235.

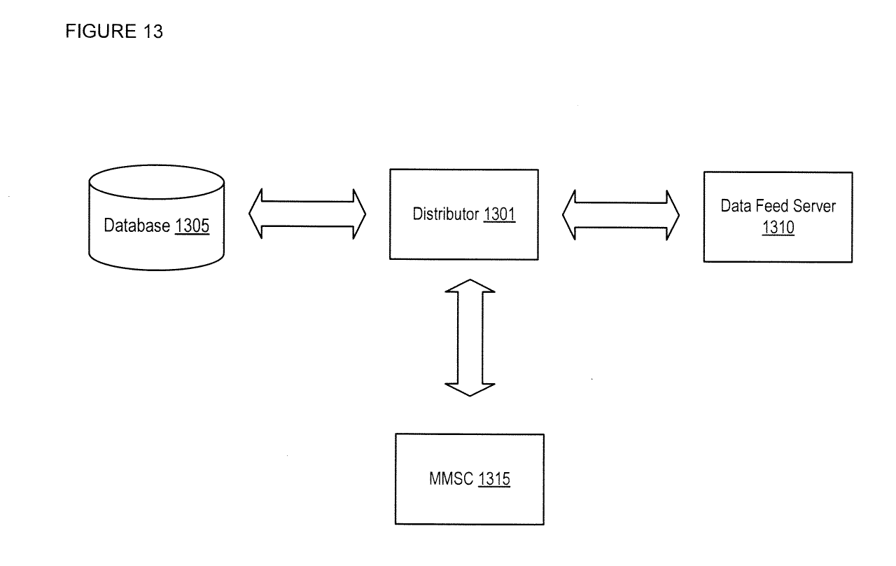

FIG. 13 shows an implementation of data flow for content delivery in one embodiment of Distributor operation. The Distributor 1301 may periodically check data feed sources for data feed updates to provide to users. The Distributor 1301 may query a database 1305, such as a profiles database, to determine which data feeds and/or data feed sources that one or more users are subscribed to. In one implementation, this query may be performed every time the Distributor is ready to send out updated data feed information to user mobile devices. In another implementation, this query may be performed less frequently, and the subscription information may be kept in temporary and/or intermediate storage between database queries. The Distributor 1301 may then communicate with one or more data feed servers and/or sources 1310 to retrieve data feed updates 1310. A data feed update may, for example, comprise RSS feed items, including a title associated with the data feed content, a description of the data feed content, and/or a link with which a user may retrieve more content associated with the data feed. The data feed update may be configured as a mobile device message, such as an SMS text message, MMS message, and/or the like, to be provided to a user mobile device. In the illustrated implementation, the data feed update information may be provided to an MMSC 1315 to be converted to an MMS message, picture alert, and/or the like and/or be subsequently sent to a user mobile device.

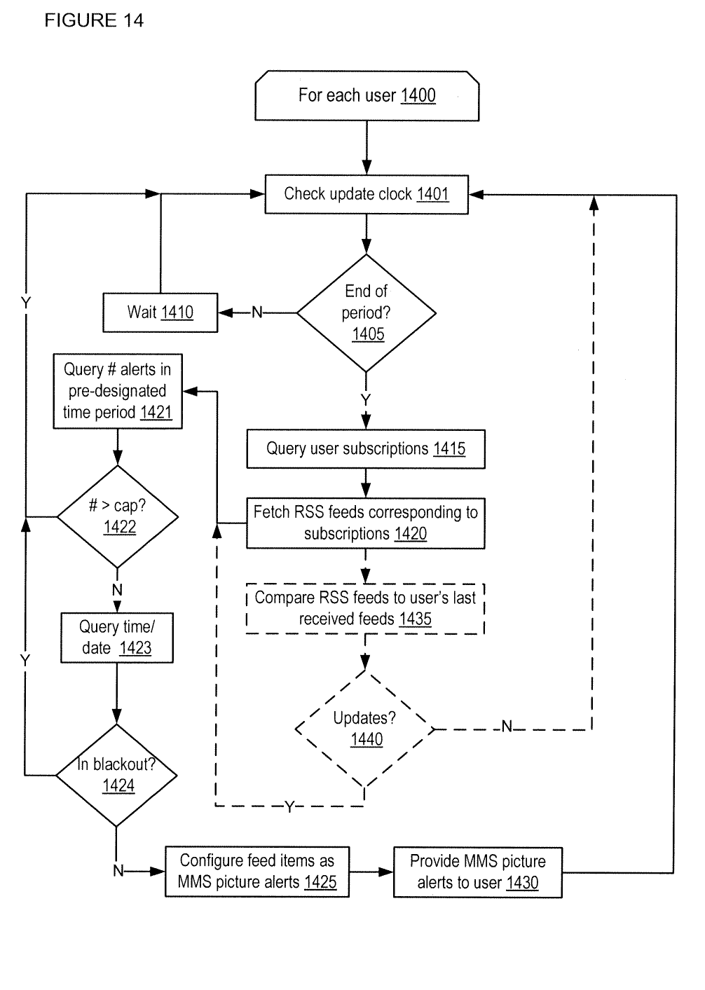

FIG. 14 shows an implementation of logic flow for content delivery in one embodiment of Distributor operation. For each Distributor user and/or feed subscriber 1400, the Distributor and/or a Distributor component (e.g., a subscription management module) may check an update clock 1401 to determine whether or not the end of a period has been reached for updating data feeds 1405. In one implementation, a single user or subset group of all users may have a different update clock and/or schedule than other users. In another implementation, data feed updates for Distributor users may be subject to the same update schedule and/or clock. If the end of a period has not been reached, the Distributor may wait for a designated period of time 1410 before again checking the clock 1401. Otherwise, the Distributor may query user subscriptions 1415, such as may be stored in a profiles database and/or in an intermediary storage repository, to determine which data feed sources, content providers, and/or the like to query for updates. The Distributor may communicate with the one or more determined data feed sources to fetch data feed (e.g., RSS feed) information corresponding to the queried user subscription information 1420. In one implementation, the Distributor may query a record, such as may be stored in association with a user profile, of the number of alerts, messages, data feed updates, and/or the like that have been sent to a user and/or a user mobile device in a pre-designated period of time (e.g., within the same day) 1421. A determination may be made as to whether that number exceeds any user-specified cap 1422 and, if so, then the update may be bypassed and the Distributor may return to 1401. Otherwise, in one implementation, the Distributor may query the current time and/or date 1423 in order to determine whether either and/or both fall within a user-designated blackout period during which he or she wishes not to receive any Distributor alerts, messages, data feed updates, and/or the like. If the current time and/or date falls within the blackout period, then the Distributor may return to 1401. Otherwise, the Distributor may configure retrieved data feed information, items (e.g., title, description, link, and/or the like), and/or the like as a mobile device message, SMS message, MMS picture alert, and/or the like 1425 for distribution to one or more selected users. In one implementation, the Distributor may pass the data feed information along to a third party MMSC to configure and send the data feed information to the user. In another implementation, the MMSC may be integrated as part of the Distributor itself. Once configured, the mobile device message (e.g., MMS picture alert) may be provided to the user and/or a user mobile device, such as via a communications network 1430.

In some implementation, a fee may be assessed for Distributor services. For example, in one implementation, a fee may be charged on a per-message basis for each data feed update, message, alert, and/or the like. In another implementation, Distributor messages, updates, alerts, and/or the like may be provided for free, but a fixed, periodically levied fee may be charged for access to Distributor services.

In one implementation, a user may be permitted to force an end-of-period and/or compel the Distributor to check for data feed updates. For example, a user may send an instruction to the Distributor, such as via an SMS text message, instructing the Distributor to immediately check for data feed updates for the data feeds to which the user is subscribed. If the Distributor discerns any updates, they may be configured as mobile device messages and provided to the user and/or a user mobile device.

In one implementation, The Distributor may proceed from 1420 to 1435 to compare data feed update information to the last data feed update sent to and/or received by a user and/or a user's mobile device. A determination may then be made as to whether there have been updates over and above the data feed information already received by the user 1440. For example, a latest data feed item title retrieved from a content provider may be compared to the last data feed item title sent to a user from the same content provider. If there has been no update over the last data feed provided to the user, the Distributor may bypass the update and return to 1401. Otherwise, the Distributor may proceed to 1421 and/or continue with the provision of Distributor functionality and/or services.

In one implementation, the Distributor may employ a delegate method for data feed updating and/or distribution, whereby one or more content providers are authorized and/or empowered by the Distributor to notify the Distributor if and when any data feed updates have been generated and/or are ready to be provided to the Distributor and/or one or more users, data feed subscribers, and/or the like.

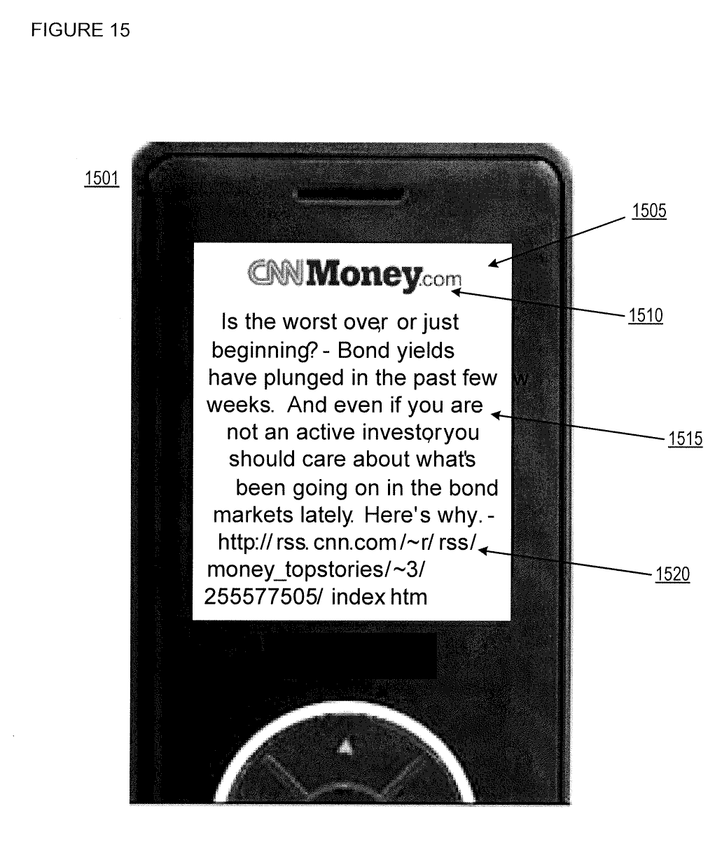

FIG. 15 shows aspects of an implementation of a user interface for content delivery in one embodiment of Distributor operation. A user's mobile device 1501 includes a display area which displays a data feed update 1505 provided by a Distributor service. The data feed update 1505 may include a title 1510. In this case, the title 1510 comprises a designation of the data feed source and/or service. The data feed update 1505 may further include a description 1515, such as a synopsis of a longer article, a low-resolution image, an abridged audio and/or video clip, and/or the like. The data feed update may further include a link 1520. In one implementation, the link 1520 is selectable and may be selected to provide further information, text and/or multimedia content, services, discounts and/or coupons, and/or the like information associated with the data feed update and/or data feed source.

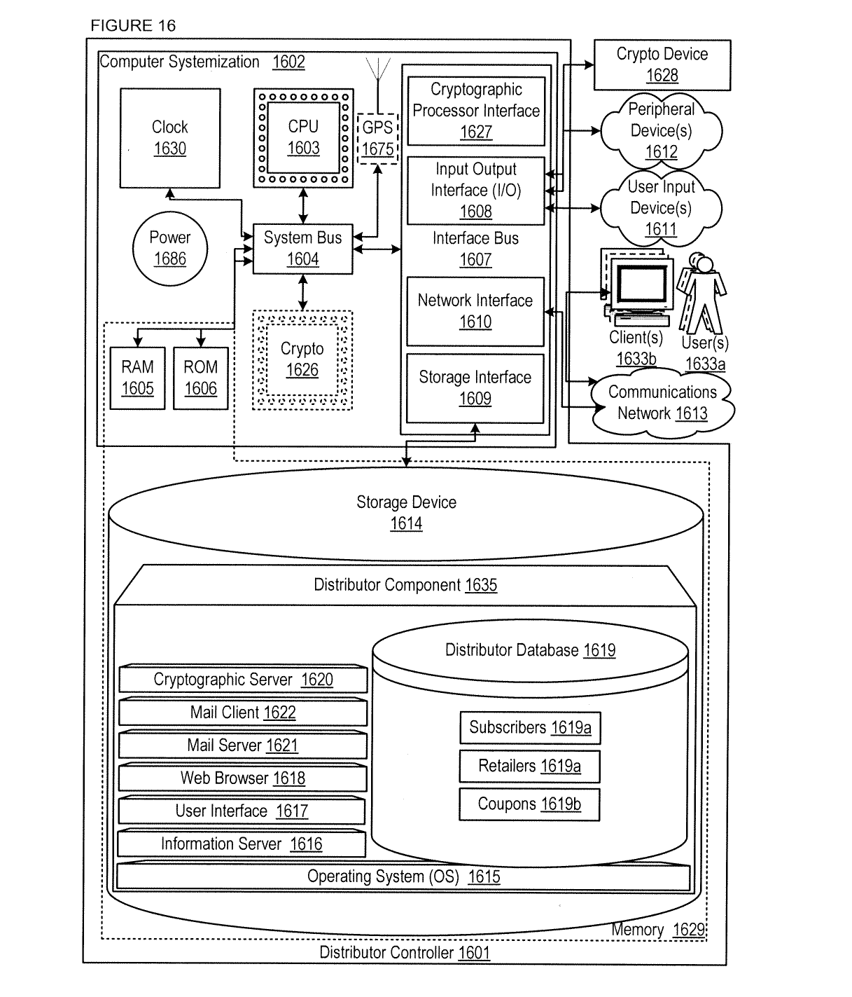

Distributor Controller FIG. 16 of the present disclosure illustrates inventive aspects of a Distributor controller 1601 in a block diagram.

Typically, users, which may be people and/or other systems, engage information technology systems (e.g., commonly computers) to facilitate information processing. In turn, computers employ processors to process information; such processors are often referred to as central processing units (CPUs). A common form of processor is referred to as a microprocessor. CPUs use communicative signals to enable various operations. Such communicative signals may be stored and/or transmitted in batches as program and/or data components facilitate desired operations. These stored instruction code signals may engage the CPU circuit components to perform desired operations. A common type of program is a computer operating system, which, commonly, is executed by CPU on a computer; the operating system enables and facilitates users to access and operate computer information technology and resources. Common resources employed in information technology systems include: input and output mechanisms through which data may pass into and out of a computer; memory storage into which data may be saved; and processors by which information may be processed. Often information technology systems are used to collect data for later retrieval, analysis, and manipulation, commonly, which is facilitated through a database program. Information technology systems provide interfaces that allow users to access and operate various system components.

In one embodiment, the Distributor controller 1601 may be connected to and/or communicate with entities such as, but not limited to: one or more users from user input devices 1611; peripheral devices 1612; a cryptographic processor device 1628; and/or a communications network 1613.

Networks are commonly thought to comprise the interconnection and interoperation of clients, servers, and intermediary nodes in a graph topology. It should be noted that the term “server” as used throughout this disclosure refers generally to a computer, other device, program, or combination thereof that processes and responds to the requests of remote users across a communications network. Servers serve their information to requesting “clients.” The term “client” as used herein refers generally to a computer, other device, program, or combination thereof that is capable of processing and making requests and obtaining and processing any responses from servers across a communications network. A computer, other device, program, or combination thereof that facilitates, processes information and requests, and/or furthers the passage of information from a source user to a destination user is commonly referred to as a “node.” Networks are generally thought to facilitate the transfer of information from source points to destinations. A node specifically tasked with furthering the passage of information from a source to a destination is commonly called a “router.” There are many forms of networks such as Local Area Networks (LANs), Pico networks, Wide Area Networks (WANs), Wireless Networks (WLANs), etc. For example, the Internet is generally accepted as being an interconnection of a multitude of networks whereby remote clients and servers may access and interoperate with one another.

The Distributor controller 1601 may be based on common computer systems that may comprise, but are not limited to, components such as: a computer systemization 1602 connected to memory 1629.

Computer Systemization

A computer systemization 1602 may comprise a clock 1630, central processing unit (CPU) 1603, a read only memory (ROM) 1606, a random access memory (RAM) 1605, and/or an interface bus 1607, and most frequently, although not necessarily, the foregoing are interconnected and/or communicating through a system bus 1604. Optionally, the computer systemization may be connected to an internal power source 1686. Optionally, a cryptographic processor 1626 and/or a global positioning system (GPS) component 1675 may be connected to the system bus. The system clock typically has a crystal oscillator and provides a base signal. The clock is typically coupled to the system bus and various clock multipliers that will increase or decrease the base operating frequency for other components interconnected in the computer systemization. The clock and various components in a computer systemization drive signals embodying information throughout the system. Such transmission and reception of signals embodying information throughout a computer systemization may be commonly referred to as communications. These communicative signals may further be transmitted, received, and the cause of return and/or reply signal communications beyond the instant computer systemization to: communications networks, input devices, other computer systemizations, peripheral devices, and/or the like. Of course, any of the above components may be connected directly to one another, connected to the CPU, and/or organized in numerous variations employed as exemplified by various computer systems.

The CPU comprises at least one high-speed data processor adequate to execute program components for executing user and/or system-generated requests. The CPU may be a microprocessor such as AMD's Athlon, Duron and/or Opteron; IBM and/or Motorola's PowerPC; IBM's and Sony's Cell processor; Intel's Celeron, Itanium, Pentium, Xeon, and/or XScale; and/or the like processor(s). The CPU interacts with memory through signal passing through conductive conduits to execute stored signal program code according to conventional data processing techniques. Such signal passing facilitates communication within the Distributor controller and beyond through various interfaces. Should processing requirements dictate a greater amount of speed, parallel, mainframe and/or super-computer architectures may similarly be employed. Alternatively, should deployment requirements dictate greater portability, smaller Personal Digital Assistants (PDAs) may be employed.

Power Source

The power source 1686 may be of any standard form for powering small electronic circuit board devices such as the following power cells: alkaline, lithium hydride, lithium ion, lithium polymer, nickel cadmium, solar cells, and/or the like. Other types of AC or DC power sources may be used as well. In the case of solar cells, in one embodiment, the case provides an aperture through which the solar cell may capture photonic energy. The power cell 1686 is connected to at least one of the interconnected subsequent components of the Distributor thereby providing an electric current to subsequent components. In one example, the power source 1686 is connected to the system bus component 1604. In an alternative embodiment, an outside power source 1686 is provided through a connection across the I/O 1608 interface. For example, a USB and/or IEEE 1394 connection carries both data and power across the connection and is therefore a suitable source of power.

Interface Adapters

Interface bus(es) 1607 may accept, connect, and/or communicate to a number of interface adapters, conventionally although not necessarily in the form of adapter cards, such as, but not limited to: input output interfaces (I/O) 1608, storage interfaces 1609, network interfaces 1610, and/or the like. Optionally, cryptographic processor interfaces 1627 similarly may be connected to the interface bus. The interface bus provides for the communications of interface adapters with one another as well as with other components of the computer systemization. Interface adapters are adapted for a compatible interface bus. Interface adapters conventionally connect to the interface bus via a slot architecture. Conventional slot architectures may be employed, such as, but not limited to: Accelerated Graphics Port (AGP), Card Bus, (Extended) Industry Standard Architecture ((E)ISA), Micro Channel Architecture (MCA), NuBus, Peripheral Component Interconnect (Extended) (PCI(X)), PCI Express, Personal Computer Memory Card International Association (PCMCIA), and/or the like.

Storage interfaces 1609 may accept, communicate, and/or connect to a number of storage devices such as, but not limited to: storage devices 1614, removable disc devices, and/or the like. Storage interfaces may employ connection protocols such as, but not limited to: (Ultra) (Serial) Advanced Technology Attachment (Packet Interface) ((Ultra) (Serial) ATA(PI)), (Enhanced) Integrated Drive Electronics ((E)IDE), Institute of Electrical and Electronics Engineers (IEEE) 1394, fiber channel, Small Computer Systems Interface (SCSI), Universal Serial Bus (USB), and/or the like.

Network interfaces 1610 may accept, communicate, and/or connect to a communications network 1613. Through a communications network 1613, the Distributor controller is accessible through remote clients 1633b (e.g., computers with web browsers) by users 1633a. Network interfaces may employ connection protocols such as, but not limited to: direct connect, Ethernet (thick, thin, twisted pair 10/100/1000 Base T, and/or the like), Token Ring, wireless connection such as IEEE 802.11a-x, and/or the like. A communications network may be any one and/or the combination of the following: a direct interconnection; the Internet; a Local Area Network (LAN); a Metropolitan Area Network (MAN); an Operating Missions as Nodes on the Internet (OMNI); a secured custom connection; a Wide Area Network (WAN); a wireless network (e.g., employing protocols such as, but not limited to a Wireless Application Protocol (WAP), I-mode, and/or the like); and/or the like. A network interface may be regarded as a specialized form of an input output interface. Further, multiple network interfaces 1610 may be used to engage with various communications network types 1613. For example, multiple network interfaces may be employed to allow for the communication over broadcast, multicast, and/or unicast networks.

Input Output interfaces (I/O) 1608 may accept, communicate, and/or connect to user input devices 1611, peripheral devices 1612, cryptographic processor devices 1628, and/or the like. I/O may employ connection protocols such as, but not limited to: Apple Desktop Bus (ADB); Apple Desktop Connector (ADC); audio: analog, digital, monaural, RCA, stereo, and/or the like; IEEE 1394a-b; infrared; joystick; keyboard; midi; optical; PC AT; PS/2; parallel; radio; serial; USB; video interface: BNC, coaxial, composite, digital, Digital Visual Interface (DVI), RCA, RF antennae, S-Video, VGA, and/or the like; wireless; and/or the like. A common output device is a television set, which accepts signals from a video interface. Also, a video display, which typically comprises a Cathode Ray Tube (CRT) or Liquid Crystal Display (LCD) based monitor with an interface (e.g., DVI circuitry and cable) that accepts signals from a video interface, may be used. The video interface composites information generated by a computer systemization and generates video signals based on the composited information in a video memory frame. Typically, the video interface provides the composited video information through a video connection interface that accepts a video display interface (e.g., an RCA composite video connector accepting an RCA composite video cable; a DVI connector accepting a DVI display cable, etc.).

User input devices 1611 may be card readers, dongles, finger print readers, gloves, graphics tablets, joysticks, keyboards, mouse (mice), remote controls, retina readers, trackballs, trackpads, and/or the like.

Peripheral devices 1612 may be connected and/or communicate to I/O and/or other facilities of the like such as network interfaces, storage interfaces, and/or the like. Peripheral devices may be audio devices, cameras, dongles (e.g., for copy protection, ensuring secure transactions with a digital signature, and/or the like), external processors (for added functionality), goggles, microphones, monitors, network interfaces, printers, scanners, storage devices, video devices, video sources, visors, and/or the like.

It should be noted that although user input devices and peripheral devices may be employed, the Distributor controller may be embodied as an embedded, dedicated, and/or monitor-less (i.e., headless) device, wherein access would be provided over a network interface connection.

Cryptographic units such as, but not limited to, microcontrollers, processors 1626, interfaces 1627, and/or devices 1628 may be attached, and/or communicate with the Distributor controller. A MC68HC16 microcontroller, commonly manufactured by Motorola Inc., may be used for and/or within cryptographic units. Equivalent microcontrollers and/or processors may also be used. The MC68HC16 microcontroller utilizes a 16-bit multiply-and-accumulate instruction in the 16 MHz configuration and requires less than one second to perform a 512-bit RSA private key operation. Cryptographic units support the authentication of communications from interacting agents, as well as allow for anonymous transactions. Cryptographic units may also be configured as part of CPU. Other commercially available specialized cryptographic processors include VLSI Technology's 33 MHz 6868 or Semaphore Communications' 40 MHz Roadrunner 184.

Memory

Generally, any mechanization and/or embodiment allowing a processor to affect the storage and/or retrieval of information is regarded as memory 1629. However, memory is a fungible technology and resource; thus, any number of memory embodiments may be employed in lieu of or in concert with one another. It is to be understood that the Distributor controller and/or a computer systemization may employ various forms of memory 1629. For example, a computer systemization may be configured wherein the functionality of on-chip CPU memory (e.g., registers), RAM, ROM, and any other storage devices are provided by a paper punch tape or paper punch card mechanism; of course, such an embodiment would result in an extremely slow rate of operation. In a typical configuration, memory 1629 will include ROM 1606, RAM 1605, and a storage device 1614. A storage device 1614 may be any conventional computer system storage. Storage devices may include a drum; a (fixed and/or removable) magnetic disk drive; a magneto-optical drive; an optical drive (i.e., CD ROM/RAM/Recordable (R), ReWritable (RW), DVD R/RW, etc.); an array of devices (e.g., Redundant Array of Independent Disks (RAID)); and/or other devices of the like. Thus, a computer systemization generally requires and makes use of memory.

Component Collection

The memory 1629 may contain a collection of program and/or database components and/or data such as, but not limited to: operating system component(s) 1615 (operating system); information server component(s) 1616 (information server); user interface component(s) 1617 (user interface); Web browser component(s) 1618 (Web browser); database(s) 1619; mail server component(s) 1621; mail client component(s) 1622; cryptographic server component(s) 1620 (cryptographic server); the Distributor component(s) 1635; and/or the like (i.e., collectively a component collection). These components may be stored and accessed from the storage devices and/or from storage devices accessible through an interface bus. Although non-conventional program components such as those in the component collection, typically, are stored in a local storage device 1614, they may also be loaded and/or stored in memory such as: peripheral devices, RAM, remote storage facilities through a communications network, ROM, various forms of memory, and/or the like.

Operating System

The operating system component 1615 is an executable program component facilitating the operation of the Distributor controller. Typically, the operating system facilitates access of I/O, network interfaces, peripheral devices, storage devices, and/or the like. The operating system may be a highly fault tolerant, scalable, and secure system such as: Apple Macintosh OS X (Server); AT&T Plan 9; Be OS; Unix and Unix and Unix-like system distributions (such as AT&T's UNIX; Berkley Software Distribution (BSD) variations such as FreeBSD, NetBSD, OpenBSD, and/or the like; Linux distributions such as Red Hat, Ubuntu, and/or the like); and/or the like operating systems. However, more limited and/or less secure operating systems also may be employed such as Apple Macintosh OS, IBM OS/2, Microsoft DOS, Microsoft Windows 2000/2003/3.1/95/98/CE/Millenium/NT/Vista/XP (Server), Palm OS, and/or the like. An operating system may communicate to and/or with other components in a component collection, including itself, and/or the like. Most frequently, the operating system communicates with other program components, user interfaces, and/or the like. For example, the operating system may contain, communicate, generate, obtain, and/or provide program component, system, user, and/or data communications, requests, and/or responses. The operating system, once executed by the CPU, may enable the interaction with communications networks, data, I/O, peripheral devices, program components, memory, user input devices, and/or the like. The operating system may provide communications protocols that allow the Distributor controller to communicate with other entities through a communications network 1613. Various communication protocols may be used by the Distributor controller as a subcarrier transport mechanism for interaction, such as, but not limited to: multicast, TCP/IP, UDP, unicast, and/or the like.

Information Server

An information server component 1616 is a stored program component that is executed by a CPU. The information server may be a conventional Internet information server such as, but not limited to Apache Software Foundation's Apache, Microsoft's Internet Information Server, and/or the like. The information server may allow for the execution of program components through facilities such as Active Server Page (ASP), ActiveX, (ANSI) (Objective−) C (++), C# and/or NET, Common Gateway Interface (CGI) scripts, Java, JavaScript, Practical Extraction Report Language (PERL), Hypertext Pre-Processor (PHP), pipes, Python, WebObjects, and/or the like. The information server may support secure communications protocols such as, but not limited to, File Transfer Protocol (FTP); HyperText Transfer Protocol (HTTP); Secure Hypertext Transfer Protocol (HTTPS), Secure Socket Layer (SSL), messaging protocols (e.g., America Online (AOL) Instant Messenger (AIM), Application Exchange (APEX), ICQ, Internet Relay Chat (IRC), Microsoft Network (MSN) Messenger Service, Presence and Instant Messaging Protocol (PRIM), Internet Engineering Task Force's (IETF's) Session Initiation Protocol (SIP), SIP for Instant Messaging and Presence Leveraging Extensions (SIMPLE), open XML-based Extensible Messaging and Presence Protocol (XMPP) (i.e., Jabber or Open Mobile Alliance's (OMA's) Instant Messaging and Presence Service (IMPS)), Yahoo! Instant Messenger Service, and/or the like. The information server provides results in the form of Web pages to Web browsers, and allows for the manipulated generation of the Web pages through interaction with other program components. After a Domain Name System (DNS) resolution portion of an HTTP request is resolved to a particular information server, the information server resolves requests for information at specified locations on the Distributor controller based on the remainder of the HTTP request. For example, a request such as http://123.124.125.126/myInformation.html might have the IP portion of the request “123.124.125.126” resolved by a DNS server to an information server at that IP address; that information server might in turn further parse the http request for the “/myInformation.html” portion of the request and resolve it to a location in memory containing the information “myInformation.html.” Additionally, other information serving protocols may be employed across various ports, e.g., FTP communications across port 21, and/or the like. An information server may communicate to and/or with other components in a component collection, including itself, and/or facilities of the like. Most frequently, the information server communicates with the Distributor database 1619, operating systems, other program components, user interfaces, Web browsers, and/or the like.

Access to the Distributor database may be achieved through a number of database bridge mechanisms such as through scripting languages as enumerated below (e.g., CGI) and through inter-application communication channels as enumerated below (e.g., CORBA, WebObjects, etc.). Any data requests through a Web browser are parsed through the bridge mechanism into appropriate grammars as required by the Distributor. In one embodiment, the information server would provide a Web form accessible by a Web browser. Entries made into supplied fields in the Web form are tagged as having been entered into the particular fields, and parsed as such. The entered terms are then passed along with the field tags, which act to instruct the parser to generate queries directed to appropriate tables and/or fields. In one embodiment, the parser may generate queries in standard SQL by instantiating a search string with the proper join/select commands based on the tagged text entries, wherein the resulting command is provided over the bridge mechanism to the Distributor as a query. Upon generating query results from the query, the results are passed over the bridge mechanism, and may be parsed for formatting and generation of a new results Web page by the bridge mechanism. Such a new results Web page is then provided to the information server, which may supply it to the requesting Web browser.

Also, an information server may contain, communicate, generate, obtain, and/or provide program component, system, user, and/or data communications, requests, and/or responses.

User Interface

The function of computer interfaces in some respects is similar to automobile operation interfaces. Automobile operation interface elements such as steering wheels, gearshifts, and speedometers facilitate the access, operation, and display of automobile resources, functionality, and status. Computer interaction interface elements such as check boxes, cursors, menus, scrollers, and windows (collectively and commonly referred to as widgets) similarly facilitate the access, operation, and display of data and computer hardware and operating system resources, functionality, and status. Operation interfaces are commonly called user interfaces. Graphical user interfaces (GUIs) such as the Apple Macintosh Operating System's Aqua, IBM's OS/2, Microsoft's Windows 2000/2003/3.1/95/98/CE/Millenium/NT/Vista (i.e., Aero)/XP, or Unix's X-Windows (e.g., which may include additional Unix graphic interface libraries and layers such as K Desktop Environment (KDE), mythTV and GNU Network Object Model Environment (GNOME)), provide a baseline and means of accessing and displaying information graphically to users.

A user interface component 1617 is a stored program component that is executed by a CPU. The user interface may be a conventional graphic user interface as provided by, with, and/or atop operating systems and/or operating environments such as already discussed. The user interface may allow for the display, execution, interaction, manipulation, and/or operation of program components and/or system facilities through textual and/or graphical facilities. The user interface provides a facility through which users may affect, interact with, and/or operate a computer system. A user interface may communicate to and/or with other components in a component collection, including itself, and/or facilities of the like. Most frequently, the user interface communicates with operating systems, other program components, and/or the like. The user interface may contain, communicate, generate, obtain, and/or provide program component, system, user, and/or data communications, requests, and/or responses.

Web Browser

A Web browser component 1618 is a stored program component that is executed by a CPU. The Web browser may be a conventional hypertext viewing application such as Microsoft Internet Explorer or Netscape Navigator. Secure Web browsing may be supplied with 128 bit (or greater) encryption by way of HTTPS, SSL, and/or the like. Some Web browsers allow for the execution of program components through facilities such as Java, JavaScript, ActiveX, web browser plug-in APIs (e.g., FireFox, Safari Plug-in, and/or the like APIs), and/or the like. Web browsers and like information access tools may be integrated into PDAs, cellular telephones, and/or other mobile devices. A Web browser may communicate to and/or with other components in a component collection, including itself, and/or facilities of the like. Most frequently, the Web browser communicates with information servers, operating systems, integrated program components (e.g., plug-ins), and/or the like; e.g., it may contain, communicate, generate, obtain, and/or provide program component, system, user, and/or data communications, requests, and/or responses. Of course, in place of a Web browser and information server, a combined application may be developed to perform similar functions of both. The combined application would similarly affect the obtaining and the provision of information to users, user agents, and/or the like from the Distributor enabled nodes. The combined application may be nugatory on systems employing standard Web browsers.

Mail Server

A mail server component 1621 is a stored program component that is executed by a CPU 1603. The mail server may be a conventional Internet mail server such as, but not limited to sendmail, Microsoft Exchange, and/or the like. The mail server may allow for the execution of program components through facilities such as ASP, ActiveX, (ANSI) (Objective−) C (++), C# and/or .NET, CGI scripts, Java, JavaScript, PERL, PHP, pipes, Python, WebObjects, and/or the like. The mail server may support communications protocols such as, but not limited to: Internet message access protocol (IMAP), Messaging Application Programming Interface (MAPI)/Microsoft Exchange, post office protocol (POP3), simple mail transfer protocol (SMTP), and/or the like. The mail server can route, forward, and process incoming and outgoing mail messages that have been sent, relayed and/or otherwise traversing through and/or to the Distributor.

Access to the Distributor mail may be achieved through a number of APIs offered by the individual Web server components and/or the operating system.

Also, a mail server may contain, communicate, generate, obtain, and/or provide program component, system, user, and/or data communications, requests, information, and/or responses.

Mail Client

A mail client component 1622 is a stored program component that is executed by a CPU 1603. The mail client may be a conventional mail viewing application such as Apple Mail, Microsoft Entourage, Microsoft Outlook, Microsoft Outlook Express, Mozilla, Thunderbird, and/or the like. Mail clients may support a number of transfer protocols, such as: IMAP, Microsoft Exchange, POP3, SMTP, and/or the like. A mail client may communicate to and/or with other components in a component collection, including itself, and/or facilities of the like. Most frequently, the mail client communicates with mail servers, operating systems, other mail clients, and/or the like; e.g., it may contain, communicate, generate, obtain, and/or provide program component, system, user, and/or data communications, requests, information, and/or responses. Generally, the mail client provides a facility to compose and transmit electronic mail messages.

Cryptographic Server

A cryptographic server component 1620 is a stored program component that is executed by a CPU 1603, cryptographic processor 1626, cryptographic processor interface 1627, cryptographic processor device 1628, and/or the like. Cryptographic processor interfaces will allow for expedition of encryption and/or decryption requests by the cryptographic component; however, the cryptographic component, alternatively, may run on a conventional CPU. The cryptographic component allows for the encryption and/or decryption of provided data. The cryptographic component allows for both symmetric and asymmetric (e.g., Pretty Good Protection (PGP)) encryption and/or decryption. The cryptographic component may employ cryptographic techniques such as, but not limited to: digital certificates (e.g., X.509 authentication framework), digital signatures, dual signatures, enveloping, password access protection, public key management, and/or the like. The cryptographic component will facilitate numerous (encryption and/or decryption) security protocols such as, but not limited to: checksum, Data Encryption Standard (DES), Elliptical Curve Encryption (ECC), International Data Encryption Algorithm (IDEA), Message Digest 5 (MD5, which is a one way hash function), passwords, Rivest Cipher (RC5), Rijndael, RSA (which is an Internet encryption and authentication system that uses an algorithm developed in 1977 by Ron Rivest, Adi Shamir, and Leonard Adleman), Secure Hash Algorithm (SHA), Secure Socket Layer (SSL), Secure Hypertext Transfer Protocol (HTTPS), and/or the like. Employing such encryption security protocols, the Distributor may encrypt incoming and/or outgoing communications and may serve as node within a virtual private network (VPN) with a wider communications network. The cryptographic component facilitates the process of “security authorization” whereby access to a resource is inhibited by a security protocol wherein the cryptographic component effects authorized access to the secured resource. In addition, the cryptographic component may provide unique identifiers of content, e.g., employing and MD5 hash to obtain a unique signature for an digital audio file. A cryptographic component may communicate to and/or with other components in a component collection, including itself, and/or facilities of the like. The cryptographic component supports encryption schemes allowing for the secure transmission of information across a communications network to enable the Distributor component to engage in secure transactions if so desired. The cryptographic component facilitates the secure accessing of resources on the Distributor and facilitates the access of secured resources on remote systems; i.e., it may act as a client and/or server of secured resources. Most frequently, the cryptographic component communicates with information servers, operating systems, other program components, and/or the like. The cryptographic component may contain, communicate, generate, obtain, and/or provide program component, system, user, and/or data communications, requests, and/or responses.

The Distributor Database

The Distributor database component 1619 may be embodied in a database and its stored data. The database is a stored program component, which is executed by the CPU; the stored program component portion configuring the CPU to process the stored data. The database may be a conventional, fault tolerant, relational, scalable, secure database such as Oracle or Sybase. Relational databases are an extension of a flat file. Relational databases consist of a series of related tables. The tables are interconnected via a key field. Use of the key field allows the combination of the tables by indexing against the key field; i.e., the key fields act as dimensional pivot points for combining information from various tables. Relationships generally identify links maintained between tables by matching primary keys. Primary keys represent fields that uniquely identify the rows of a table in a relational database. More precisely, they uniquely identify rows of a table on the “one” side of a one-to-many relationship.

Alternatively, the Distributor database may be implemented using various standard data-structures, such as an array, hash, (linked) list, struct, structured text file (e.g., XML), table, and/or the like. Such data-structures may be stored in memory and/or in (structured) files. In another alternative, an object-oriented database may be used, such as Frontier, ObjectStore, Poet, Zope, and/or the like. Object databases can include a number of object collections that are grouped and/or linked together by common attributes; they may be related to other object collections by some common attributes. Object-oriented databases perform similarly to relational databases with the exception that objects are not just pieces of data, but may have other types of functionality encapsulated within a given object. If the Distributor database is implemented as a data-structure, the use of the Distributor database 1619 may be integrated into another component such as the Distributor component 1635. Also, the database may be implemented as a mix of data structures, objects, and relational structures. Databases may be consolidated and/or distributed in countless variations through standard data processing techniques. Portions of databases, e.g., tables, may be exported and/or imported and thus decentralized and/or integrated.

In one embodiment, the database component 1619 includes several tables 1619a-b. A Subscribers table 1619a may include fields such as, but not limited to: subscriber_ID, password, subscriber_name, contact_info, hardware_ID, mobile_device_type, coupon_IDs, retailer_IDs, alerting_restrictions, payment_info, usage_history, customization_criteria, coupon_type_scores, and/or the like. A Retailers table 1619b may include fields such as, but not limited to: retailer_ID, password, retailer_name, retailer_category, contact_info, products, coupon_IDs, alerting_restrictions, cell phone_company_agreements, coupon_history, and/or the like. A Coupons table 1619c may include fields such as, but not limited to: coupon_ID, retailer_ID, coupon_code, title, description, message, retail_category, associated products, terms, conditions, restrictions, coupon_customization_template, display parameters, and/or the like. These tables may support and/or track multiple entity accounts on the Distributor controller.

In one embodiment, the Distributor database may interact with other database systems. For example, employing a distributed database system, queries and data access by search Distributor component may treat the combination of the Distributor database, an integrated data security layer database as a single database entity.

In one embodiment, user programs may contain various user interface primitives, which may serve to update the Distributor. Also, various accounts may require custom database tables depending upon the environments and the types of clients the Distributor may need to serve. It should be noted that any unique fields may be designated as a key field throughout. In an alternative embodiment, these tables have been decentralized into their own databases and their respective database controllers (i.e., individual database controllers for each of the above tables). Employing standard data processing techniques, one may further distribute the databases over several computer systemizations and/or storage devices. Similarly, configurations of the decentralized database controllers may be varied by consolidating and/or distributing the various database components 1619a-b. The Distributor may be configured to keep track of various settings, inputs, and parameters via database controllers.

The Distributor database may communicate to and/or with other components in a component collection, including itself, and/or facilities of the like. Most frequently, the Distributor database communicates with the Distributor component, other program components, and/or the like. The database may contain, retain, and provide information regarding other nodes and data.

The Distributor Component

The Distributor component 1635 is a stored program component that is executed by a CPU. In one embodiment, the Distributor component incorporates any and/or all combinations of the aspects of the Distributor that was discussed in the previous figures. As such, the Distributor affects accessing, obtaining and the provision of information, services, transactions, and/or the like across various communications networks.

The Distributor component is configurable to access, calculate, engage, exchange, generate, identify, instruct, match, process, search, serve, store, and/or facilitate user coupon subscriptions, acquisition and/or updating of coupons and/or coupon content, communications between and among retailers, MMSCs, subscribers, and/or other Distributor components, enforcement of alerting restrictions, levying of messaging fees, and/or the like and use of the Distributor.

The Distributor component enabling access of information between nodes may be developed by employing standard development tools and languages such as, but not limited to: Apache components, Assembly, ActiveX, binary executables, (ANSI) (Objective−) C (++), C# and/or .NET, database adapters, CGI scripts, Java, JavaScript, mapping tools, procedural and object oriented development tools, PERL, PHP, Python, shell scripts, SQL commands, web application server extensions, WebObjects, and/or the like. In one embodiment, the Distributor server employs a cryptographic server to encrypt and decrypt communications. The Distributor component may communicate to and/or with other components in a component collection, including itself, and/or facilities of the like. Most frequently, the Distributor component communicates with the Distributor database, operating systems, other program components, and/or the like. The Distributor may contain, communicate, generate, obtain, and/or provide program component, system, user, and/or data communications, requests, and/or responses.

Distributed Distributors

The structure and/or operation of any of the Distributor node controller components may be combined, consolidated, and/or distributed in any number of ways to facilitate development and/or deployment. Similarly, the component collection may be combined in any number of ways to facilitate deployment and/or development. To accomplish this, one may integrate the components into a common code base or in a facility that can dynamically load the components on demand in an integrated fashion.

The component collection may be consolidated and/or distributed in countless variations through standard data processing and/or development techniques. Multiple instances of any one of the program components in the program component collection may be instantiated on a single node, and/or across numerous nodes to improve performance through load-balancing and/or data-processing techniques. Furthermore, single instances may also be distributed across multiple controllers and/or storage devices; e.g., databases. Program component instances and controllers working in concert may do so through standard data processing communication techniques.

The configuration of the Distributor controller will depend on the context of system deployment. Factors such as, but not limited to, the budget, capacity, location, and/or use of the underlying hardware resources may affect deployment requirements and configuration. Regardless of if the configuration results in more consolidated and/or integrated program components, results in a more distributed series of program components, and/or results in some combination between a consolidated and distributed configuration, data may be communicated, obtained, and/or provided. Instances of components consolidated into a common code base from the program component collection may communicate, obtain, and/or provide data. This may be accomplished through intra-application data processing communication techniques such as, but not limited to: data referencing (e.g., pointers), internal messaging, object instance variable communication, shared memory space, variable passing, and/or the like.

If component collection components are discrete, separate, and/or external to one another, then communicating, obtaining, and/or providing data with and/or to other component components may be accomplished through inter-application data processing communication techniques such as, but not limited to: Application Program Interfaces (API) information passage; (distributed) Component Object Model ((D)COM), (Distributed) Object Linking and Embedding ((D)OLE), and/or the like), Common Object Request Broker Architecture (CORBA), local and remote application program interfaces Jini, Remote Method Invocation (RMI), process pipes, shared files, and/or the like. Messages sent between discrete component components for inter-application communication or within memory spaces of a singular component for intra-application communication may be facilitated through the creation and parsing of a grammar. A grammar may be developed by using standard development tools such as lex, yacc, XML, and/or the like, which allow for grammar generation and parsing functionality, which in turn may form the basis of communication messages within and between components. Again, the configuration will depend upon the context of system deployment.

The entirety of this disclosure (including the Cover Page, Title, Headings, Field, Background, Summary, Brief Description of the Drawings, Detailed Description, Claims, Abstract, Figures, and otherwise) shows by way of illustration various embodiments in which the claimed inventions may be practiced. The advantages and features of the disclosure are of a representative sample of embodiments only, and are not exhaustive and/or exclusive. They are presented only to assist in understanding and teach the claimed principles. It should be understood that they are not representative of all claimed inventions. As such, certain aspects of the disclosure have not been discussed herein. That alternate embodiments may not have been presented for a specific portion of the invention or that further undescribed alternate embodiments may be available for a portion is not to be considered a disclaimer of those alternate embodiments. It will be appreciated that many of those undescribed embodiments incorporate the same principles of the invention and others are equivalent. Thus, it is to be understood that other embodiments may be utilized and functional, logical, organizational, structural and/or topological modifications may be made without departing from the scope and/or spirit of the disclosure. As such, all examples and/or embodiments are deemed to be non-limiting throughout this disclosure. Also, no inference should be drawn regarding those embodiments discussed herein relative to those not discussed herein other than it is as such for purposes of reducing space and repetition. For instance, it is to be understood that the logical and/or topological structure of any combination of any program components (a component collection), other components and/or any present feature sets as described in the figures and/or throughout are not limited to a fixed operating order and/or arrangement, but rather, any disclosed order is exemplary and all equivalents, regardless of order, are contemplated by the disclosure. Furthermore, it is to be understood that such features are not limited to serial execution, but rather, any number of threads, processes, services, servers, and/or the like that may execute asynchronously, concurrently, in parallel, simultaneously, synchronously, and/or the like are contemplated by the disclosure. As such, some of these features may be mutually contradictory, in that they cannot be simultaneously present in a single embodiment. Similarly, some features are applicable to one aspect of the invention, and inapplicable to others. In addition, the disclosure includes other inventions not presently claimed. Applicant reserves all rights in those presently unclaimed inventions including the right to claim such inventions, file additional applications, continuations, continuations in part, divisions, and/or the like thereof. As such, it should be understood that advantages, embodiments, examples, functional, features, logical, organizational, structural, topological, and/or other aspects of the disclosure are not to be considered limitations on the disclosure as defined by the claims or limitations on equivalents to the claims.

What is claimed is:

1. A method, comprising:
receiving at a server a user coupon subscription message from a user, the user coupon subscription message comprising a user identifier and an authorization to send coupons to a user mobile device;
determining a retail identifier based on the user coupon subscription message;
storing the retail identifier in association with the user identifier in a database;
receiving at a server a coupon specification message comprising the retail identifier, a coupon code and a coupon benefit message;
storing some part of the coupon specification message in association with the retail identifier in a database; and
providing a coupon message for distribution to a user mobile device associated with the user identifier, the coupon message configured with the coupon code and the coupon benefit message.

2. The method of claim 1, wherein the user coupon subscription message further comprises a geographic identifier and the determining a retail identifier is based on the geographic identifier.

3. The method of claim 1, wherein the user coupon subscription message further comprises a retail category and the determining a retail identifier is based on the retail category.

4. The method of claim 1, wherein the user coupon subscription message further comprises the retail identifier and the determining a retail identifier comprises receipt of the retail identifier.

5. The method of claim 1, wherein the user coupon subscription message further comprises a coupon receipt restriction.

6. The method of claim 5, wherein the coupon receipt restriction comprises a blackout time period, and the providing a coupon message for distribution to a user mobile device only occurs during a time that is outside the blackout time period.

7. The method of claim 1, wherein the coupon code is configured to trigger a purchase discount for a purchase associated with the retail identifier.

8. The method of claim 7, further comprising:
querying a user characteristic associated with the user identifier; and
determining the purchase discount based on the user characteristic.

9. The method of claim 8, wherein the user characteristic comprises a number of unused mobile telephone service minutes.

10. The method of claim 8, wherein the user characteristic comprises a user mobile telephone bill payment history.

11. The method of claim 7, wherein the coupon message is further configured with a user identifier code and wherein the coupon code only triggers the purchase discount if it is paired with a matching user identifier code.

12. The method of claim 1, wherein the coupon message is configured as a multimedia messaging service message.

13. The method of claim 1, wherein the coupon message includes a scannable barcode configured with the coupon code.

14. The method of claim 1, wherein the retail identifier comprises a retailer identifier.

15. The method of claim 1, wherein the retail identifier comprises an identifier for retail goods or services.

16. The method of claim 1, wherein the user coupon subscription message further comprises a geographic identifier and a retail category, and wherein determining a retail identifier further comprises:
querying a retailer database based on the geographic identifier and the retail category to extract a plurality of retailer identifiers;
providing the plurality of retailer identifiers for display to the user;
receiving a selection of at least one retailer identifier from the plurality of retailer identifiers; and
wherein the retail identifier comprises the selected retailer identifier.

17. The method of claim 1, wherein the coupon message is fed into a virtual publication interface for display on the user mobile device.

18. A system, comprising:
a processor;
a memory in communication with the processor and containing program instructions;
an input and output in communication with the processor and memory comprising a graphical interface;
wherein the processor executes program instructions contained in the memory and the program instructions comprise:
receive a user coupon subscription message from a user, the user coupon subscription message comprising a user identifier and an authorization to send coupons to a user mobile device;
determine a retail identifier based on the user coupon subscription message;
store the retail identifier in association with the user identifier;
receive a coupon specification message comprising the retail identifier, a coupon code and a coupon benefit message;
store some part of the coupon specification message in association with the retail identifier; and
provide a coupon message for distribution to a user mobile device associated with the user identifier, the coupon message configured with the coupon code and the coupon benefit message.

19. A computer program product, comprising:
processor readable instructions stored in the computer program product, wherein the processor readable instructions are issuable by a processor to:
receive a user coupon subscription message from a user, the user coupon subscription message comprising a user identifier and an authorization to send coupons to a user mobile device;
determine a retail identifier based on the user coupon subscription message;
store the retail identifier in association with the user identifier;
receive a coupon specification message comprising the retail identifier, a coupon code and a coupon benefit message;
store some part of the coupon specification message in association with the retail identifier; and
provide a coupon message for distribution to a user mobile device associated with the user identifier, the coupon message configured with the coupon code and the coupon benefit message.

20. A method, comprising:
receiving at a server a user coupon subscription message from a user mobile device, the user coupon subscription message comprising a geographic identifier, a retail category, a user identifier and an authorization to send coupons to a user mobile device;
querying a retailer database based on the geographic identifier and the retail category to extract a plurality of retailer identifiers;
providing the plurality of retailer identifiers for display to the user via a user interface;
receiving a selection of at least one retailer identifier from the plurality of retailer identifiers;
determining a retailer RSS feed address based on the at least one retailer identifier;
storing the retailer RSS feed address in association with the user identifier in a database;
receiving at a server at least one retailer coupon code from a content provider associated with the retailer RSS feed address; and
providing the at least one retailer coupon code to be sent as a mobile device message to the user mobile device, wherein the mobile device message is configured as a multimedia messaging service message and wherein the coupon code is configured as a scannable bar code.
